(19) United States
(12) Patent Application Publication
(10) Pub. No.: US 2015/0207866 A1
(43) Pub. Date: Jul. 23, 2015

(54) DETERMINATION DEVICE AND DETERMINATION METHOD

(71) Applicant: FUJITSU LIMITED, Kawasaki-shi (JP)

(72) Inventors: Hiroyuki Fujie, Yokohama (JP); Daiki Hanawa, Kawasaki (JP); Kazuyuki Sakai, Nissin (JP)

(73) Assignee: Fujitsu Limited, Kawasaki (JP)

(21) Appl. No.: 14/595,588

(22) Filed: Jan. 13, 2015

(30) Foreign Application Priority Data
Jan. 21, 2014 (JP) 2014-008320

(51) Int. Cl. H04L 29/08

(52) U.S. Cl. CPC H04L 67/10

(57) ABSTRACT

A non-transitory computer-readable recording medium having stored therein a program for causing a computer to execute a process, the process includes; dividing multiple processes in a process definition, in which the multiple processes for an operation target in an information processing system are defined, into multiple groups based on partition information indicating a partition of a unit of the processes; determining a type of each of the divided groups based on the processes belonging to the group; and determining a type of the process definition based on the determined types of the groups.

### CROSS-REFERENCE TO RELATED APPLICATION

This application is based upon and claims the benefit of priority of the prior Japanese Patent Application No. 2014-008320, filed on Jan. 21, 2014, the entire contents of which are incorporated herein by reference.

### FIELD

The embodiments discussed herein are related to a recording medium storing a program, a determination device, and a determination method.

### BACKGROUND

There has been proposed a technique for automating multiple operation works to be manually carried out by a system operator, by defining the multiple operation works as an Automated Operation Process and executing the Automated Operation Processes.

For example, an operator instructs a management server of a system to display Automated Operation Processes which the operator has an authority to start. In response to the display instruction, the management server displays, on a display device, the Automated Operation Processes which the operator has an authority to start among Automated Operation Processes stored in the system. The operator finds a desired Automated Operation Process among the displayed Automated Operation Processes and instructs the management server to execute the found Automated Operation Process by, for example, selecting the found Automated Operation Process on a screen.

A related technique is disclosed in Japanese Laid-open Patent Publication No. 2004-171586.

When many Automated Operation Processes are displayed, it is difficult for an operator to find a desired Automated Operation Process among the displayed Automated Operation Processes. As a result, a work efficiency of the operation works may be decreased and a long time may elapse before executing the desired Automated Operation Process.

For example, when an error occurs in an operation target (for example, a server of a system), this error is desirably handled by quickly finding, among many Automated Operation Processes displayed, an Automated Operation Process defined to execute processes on the operation target. In such an emergency, a type of the Automated Operation Process relevant to the error-handling to be executed has to be identified in order to quickly handle the error. In other words, the work efficiency of the operation processes is desired to be increased by determining a type of a process definition in which multiple processes are defined.

According to an aspect of the embodiment, it is desirable to determine a type of a process definition in which multiple processes are defined.

### SUMMARY

According to an aspect of the invention, disclosed is a non-transitory computer-readable recording medium having stored therein a program for causing a computer to execute a process, the process includes; dividing multiple processes in a process definition, in which the multiple processes for an operation target in an information processing system are defined, into multiple groups based on partition information indicating a partition of a unit of the processes; determining a type of each of the divided groups based on the processes belonging to the group; and determining a type of the process definition based on the determined types of the groups.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example diagram illustrating an information processing system SYS in an embodiment;

FIG. 2 is an example block diagram illustrating a configuration of a management server in FIG. 1;

FIG. 3 is an example diagram schematically illustrating an Automated Operation Process described in FIG. 2;

FIG. 4 is a diagram illustrating an example display of the Automated Operation Process;

FIG. 5 is an example flowchart schematically illustrating a display process for the Automated Operation Process in the embodiment;

FIG. 6 is an example flowchart illustrating a process flow of retrieving a display target Automated Operation Process at step S2 in FIG. 5;

FIG. 7 is a diagram illustrating an example table storing operation parts and names of software corresponding to the operation parts;

FIG. 8 is a diagram illustrating an example table storing terms of software and names of the software;

FIG. 9 is an example flowchart illustrating a process flow of determining a type of the retrieved Automated Operation Process at step S3 in FIG. 5;

FIGS. 10A and 10B are diagrams (first) illustrating a master pattern which is referred to when the type of the Automated Operation Process is determined;

FIG. 11 is a diagram (second) illustrating a master pattern which is referred to when the type of the Automated Operation Process is determined;

FIG. 12 is a diagram (third) illustrating a master pattern which is referred to when the type of the Automated Operation Process is determined;

FIG. 13 is a diagram (fourth) illustrating a master pattern which is referred to when the type of the Automated Operation Process is determined;

FIG. 14 is a diagram (fifth) illustrating a master pattern which is referred to when the type of the Automated Operation Process is determined;

FIGS. 15A to 15D are diagrams illustrating a process of extracting a pattern of an operation part on a normal route in the display target Automated Operation

Process at step 303 in FIG. 9;

FIGS. 16A and 16B are diagrams (first) specifically illustrating a type determination for the Automated Operation Process;

FIGS. 17A and 17B are diagrams (second) specifically illustrating a type determination for the Automated Operation Process;

FIGS. 18A and 18B are diagrams (third) specifically illustrating a type determination for the Automated Operation Process;

FIG. 19 is an example flowchart illustrating creation processing for a start history;

FIG. 20 is a diagram schematically illustrating a start history;

FIG. 21 is an example flowchart illustrating a process flow of determining an order of displaying information about the retrieved Automated Operation Process based on the determined type at step S4 in FIG. 5;

FIG. 22 is a diagram illustrating a process of counting the start histories per time slot at step S403 in FIG. 19;

FIG. 23 is a diagram illustrating a process of calculating a priority for each display target Automated Operation Process at step S404 in FIG. 19; and

FIG. 24 is a diagram illustrating an example display of the Automated Operation Process in the embodiment.

### DESCRIPTION OF EMBODIMENTS

### (Information Processing System)

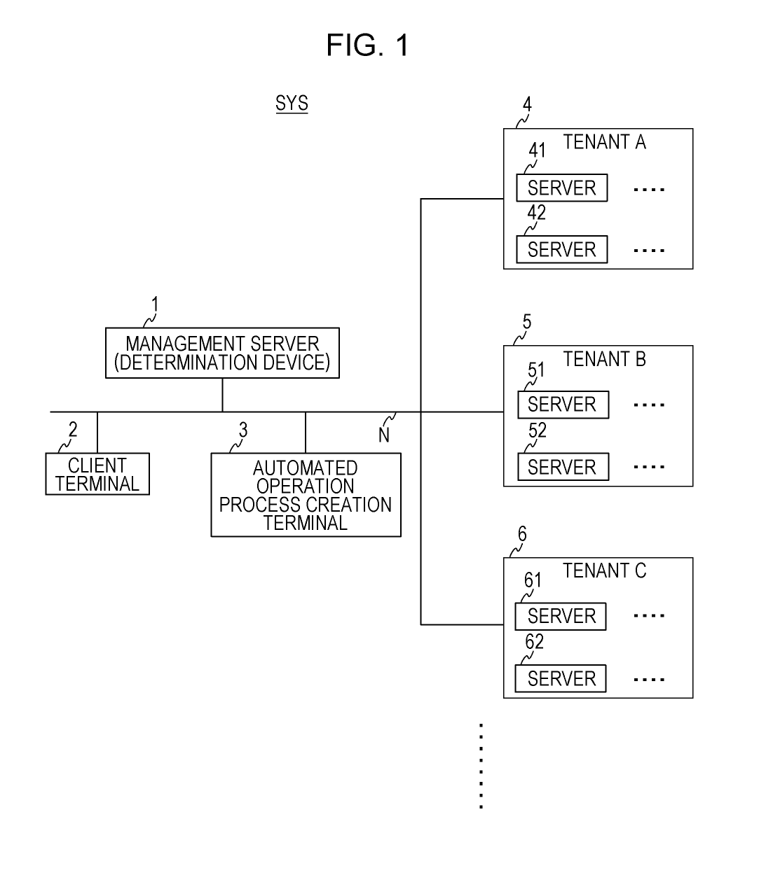

FIG. 1 is an example diagram illustrating an information processing system SYS in an embodiment. Hereinafter, same reference numerals are given to denote similar configuration and the duplicated description is omitted as appropriately. In the following description, “ . . .” indicates the omission.

The information processing system SYS has a management server 1, a client terminal 2, an Automated Operation Process creation terminal 3, a tenant A4, a tenant B5, a tenant C6, and . . . , those of which are connected with one another through a network N such as a local area network (LAN) or a wide area network (WAN). Here, other tenants are omitted. The management server (determination device) is expressed as a management server 1 as appropriate.

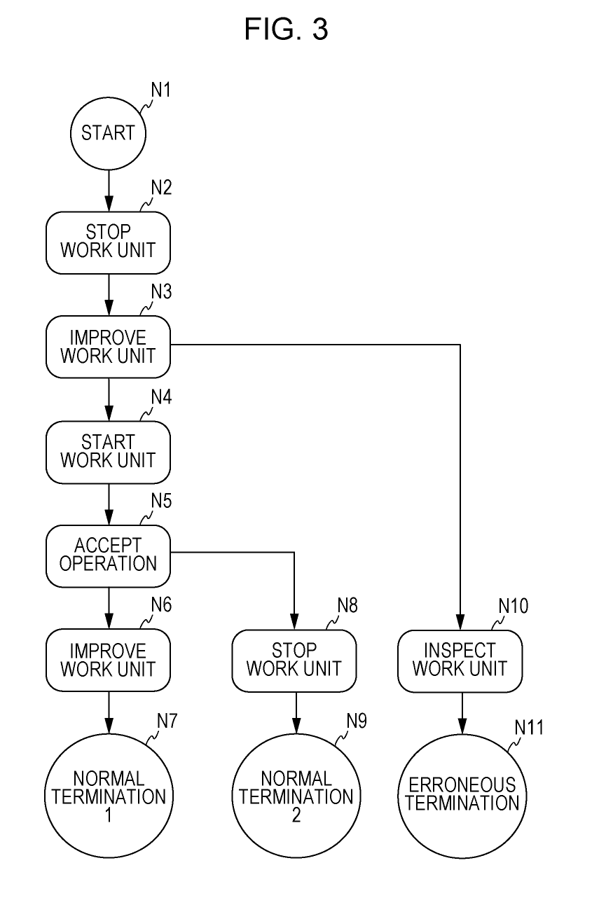

The management server 1 is a server to execute various kinds of processes for managing the information processing system SYS. The client terminal 2 is a terminal to operate the management server 1. The Automated Operation Process creation terminal 3 creates an Automated Operation Process and stores it in the management server 1. The Automated Operation Process is described in detail by using FIG. 3. A developer of the Automated Operation Process operates the Automated Operation Process creation terminal 3 to develop an Automated Operation Process.

The tenant A4, the tenant B5, the tenant C6, and . . . indicate a unit in which multiple servers are included. For example, when the information processing system SYS provides clients with a cloud service (Iaas: Infrastructure as a Service), multiple servers executing a service which is provided to the clients are collectively referred to as a tenant.

The tenant A4 has multiple servers, for example, a server 41, a server 42, and . . . . The tenant B5 has multiple servers, for example, a server 51, a server 52, and . . . . The tenant C6 has multiple servers, for example, a server 61, a server 62, and . . . . The servers of each tenant are connected with the network N.

An operator of the information processing system SYS makes an access to the management server 1 by operating the client terminal 2, and gives an instruction to the Automated Operation Process which is stored in the management server 1, for example, in the system.

### (Management Server)

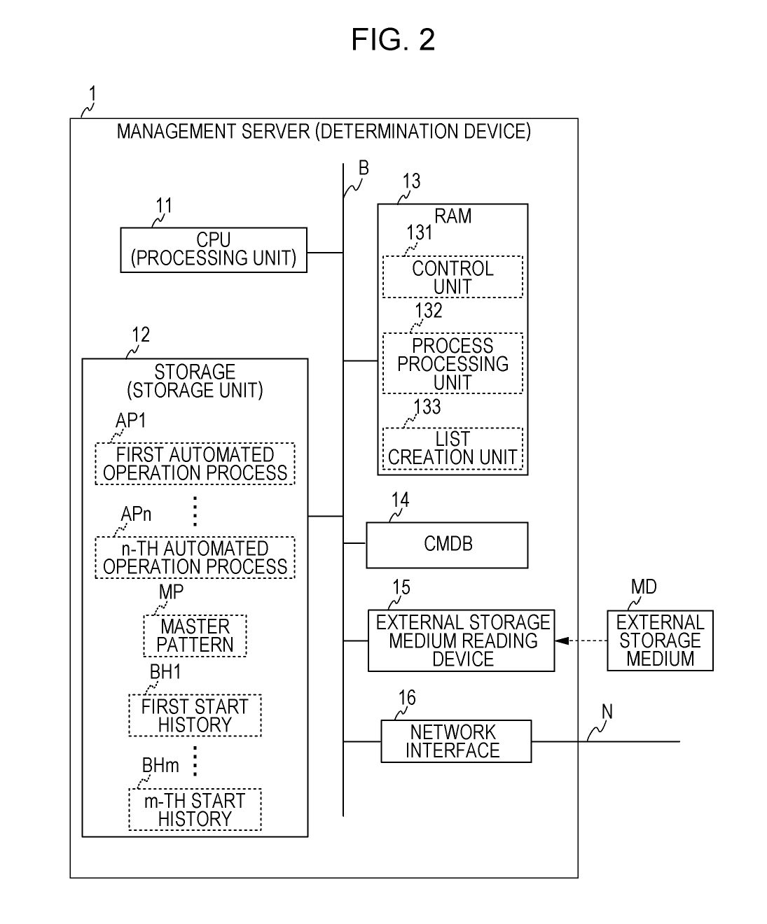

FIG. 2 is an example block diagram illustrating a configuration of the management server 1 in FIG. 1.

The management server 1 has a CPU (processing unit) 11, a storage (storage unit) 12, a RAM 13, and a CMDB 14. Here, the CPU stands for a “central processing unit”, the RAM stands for a “random access memory”, and the CMDB stands for “configuration management database”. Hereinafter, the CPU (processing unit) 11 is expressed as a CPU 11, and the storage (storage unit) 12 is expressed as a storage 12 as appropriate.

Furthermore, the management server 1 has an external storage medium reading device 15 and a network interface 16, both of which are connected with a bus B.

The CPU 11 is a central processing unit to control the entire management server 1. The storage 12 is a large capacity storage device such as a hard disk drive (HDD) or a solid state drive (SSD). The storage 12 stores a first Automated Operation Process AP1 to an n-th (n is 2 or larger integer) Automated Operation Process APn, a master pattern MP, and a first start history BH1 to an m-th (m is 2 or larger integer) start history BHm.

The Automated Operation Process is a data file including information defining multiple processes for an operation target (also referred to as a control target), and is stored in a table format or an extensible markup language (XML) format, for example. The operation target is a device (for example, a server) in the information processing system SYS or any piece of software (also referred to as services) installed in the device, or both of the device and the software. The server which is an operation target includes not only a physical server but also a virtual server, so-called a virtual machine (VM). Here, an example process definition in which multiple processes for an operation target in the information processing system SYS are defined is an Automated Operation Process.

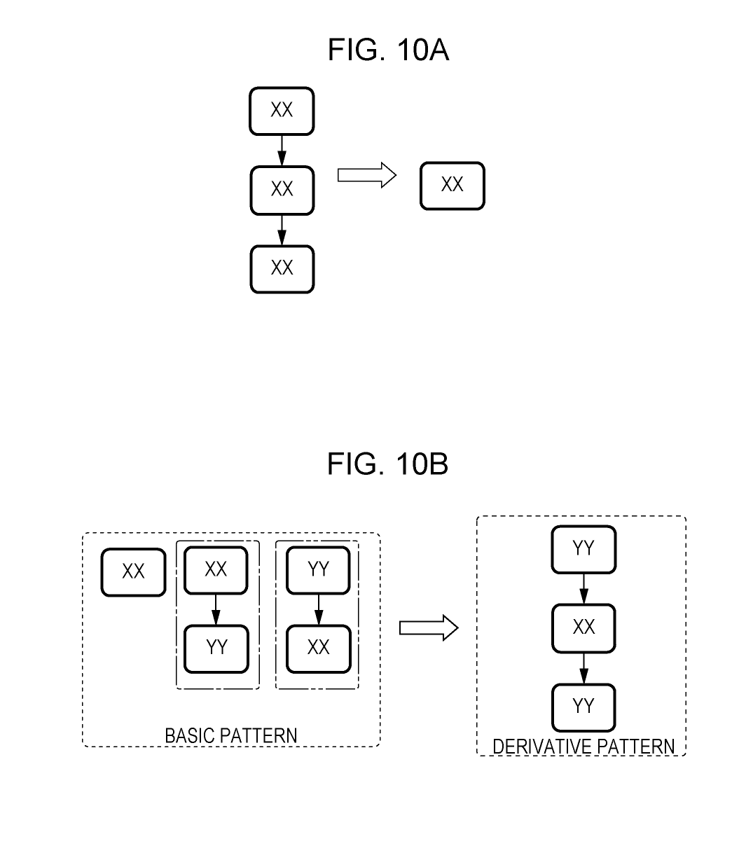

The master pattern MP is an example of type-specific information indicating a type of a patterned operation part (also referred to as a first node). The master pattern is described in detail by using FIGS. 10A to 14.

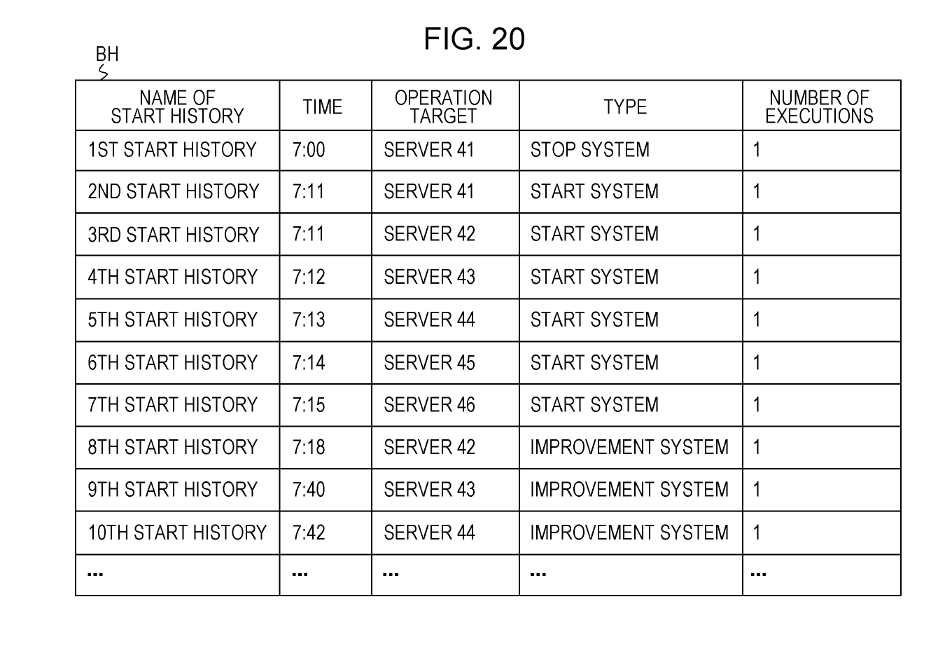

The first start history BH1 to the m-th start history BHm are histories relating to the executed Automated Operation Process when the Automated Operation Process is started (also referred to as executed). The start history is described in FIG. 20.

The RAM 13 temporarily stores data processed at each of steps executed by the CPU 11. The RAM 13 is a semiconductor memory such as a dynamic random access memory (DRAM), for example.

The description is given to a control unit 131, a process processing unit 132, and a list creation unit 133 in the RAM 13. The control unit controls a management process of the information processing system SYS, the process processing unit 132, and the list creation unit 133.

It is to be noted that “-unit” in the RAM 13 is specifically a storage area, which implements a specific function on the management server by running a specific program developed in that area.

The process processing unit 132 executes an instructed Automated Operation Process out of the first Automated Operation Process AP1 to the n-th Automated Operation Process APn in response to an execution instruction from the client terminal 2.

The list creation unit 133 creates data for displaying information about the Automated Operation Process (for example, the name of the Automated Operation Process) corresponding to the display instruction in the first Automated Operation Process AP1 to the n-th Automated Operation Process APn in response to the display instruction from the client terminal 2. Then, the list creation unit 133 transmits the created data for display to the client terminal 2.

The storage 12 stores execution files (programs) of the control unit 131, the process processing unit 132, and the list creation unit 133. The CPU 11 realizes functions as the control unit 131, the process processing unit 132, and the list creation unit 133 by reading the execution files from the storage 12 and running them in the RAM 13. Alternatively, those execution files may be stored in an external storage medium MD.

The CMDB 14 is configuration management database and includes a database server collecting configuration information from a device (for example, an operation target server) in the system in the information processing system SYS.

In other words, the CMDB 14 collectively manages the configuration information of the operation target server. The configuration information includes information about the server and information about software installed in the server. For example, the information about software includes a name and identification sign of a server, an internet protocol (IP) address set in the server, a name and identification sign of hardware included in the server. For example, the information about this software includes a name, term, and identification sign of the software.

Also, the CMDB 14 manages relationship information (relationship) indicating a relationship among pieces of configuration information other than the configuration information of the operation target server.

The CMDB 14 collects the configuration information by regularly making an access to the operation target server. Besides, the CMDB 14 collects the configuration information, for example, when the server transmits the configuration information regularly to the CMDB 14 or every time the configuration information is changed. Then, the CMDB 14 stores the collected configuration information as a configuration item (CI).

The external storage medium reading device 15 is a device to read data stored in the external storage medium MD. For example, the external storage medium MD is a portable storage medium such as a compact disc read only memory (CD-ROM) or a digital versatile disc (DVD) or a portable non-volatile memory such as a USB memory.

The network interface 16 has a network interface card (NIC), for example, to provide an interface function to the network N.

### (Automated Operation Process)

FIG. 3 is an example diagram schematically illustrating the Automated Operation Process described in FIG. 2. The Automated Operation Process in FIG. 3 is any one of the first Automated Operation Process PA1 to the n-th Automated Operation Process APn in FIG. 2.

The Automated Operation Process includes multiple nodes, connection information indicating a connection relationship between the nodes, and an identifier to identify the Automated Operation Process. In FIG. 3, a node is illustrated by a square frame and connection information is illustrated by an arrow. Then, a name of the node is written inside the square frame indicating the node. The Automated Operation Process executes each node in the order illustrated by an arrow between the nodes. It is to be noted that a work unit in FIG. 3 is an operation unit of an application.

For example, the operation target of the Automated Operation Process in FIG. 3 is software (hereinafter, expressed as software TG) installed in a server in FIG. 1.

Here, the node is described. The Automated Operation Process includes multiple first nodes. A first node is defined for each process and indicates the process and a type of the process. The first node is also referred to as an operation part which performs a certain process (operation) on the operation target.

For example, the node which is an operation part includes a stop system node, an improvement system node, a start system node, and an inspection system node.

Furthermore, the Automated Operation Process includes at least one second node which is partition information indicating a partition of a unit of the processes expressed by one or more first nodes (operation parts). Furthermore, the Automated Operation Process includes connection information indicating a connection relationship between the first and second nodes. This connection information is connection information between the first nodes and between the first and second nodes.

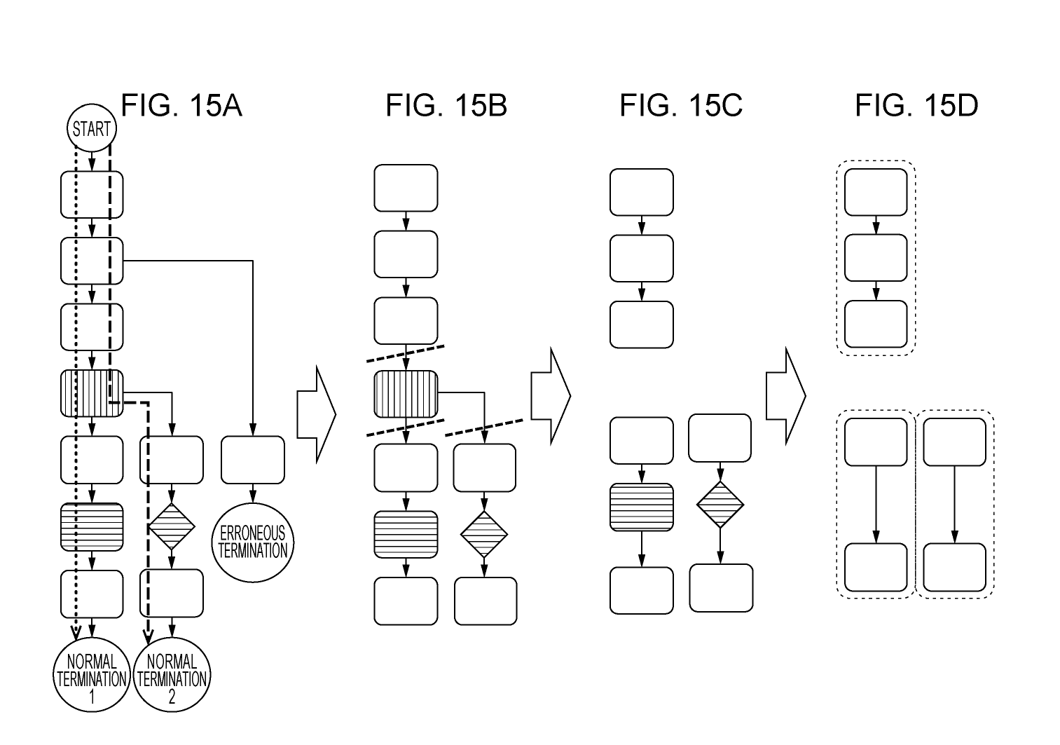

In addition, the node includes an activity node which is a node in which a work to be manually performed by an operator or the like is expressed. The node also includes an identification node to display information on a start or stop of the Automated Operation Process. Other nodes are described in FIG. 15.

A start node N1 is an identification node indicating a start of the Automated Operation Process.

A node N2 is a stop system node which executes a stop process of software TG. The stop system node transmits a stop instruction command to the operation target server or software, and executes the stop process on the server and software. In addition, the stop system node may stop the server or the software and executes a process switching to a server or software having a function equivalent to that of the stopped server or software.

A node N3 is an improvement system node to apply a first patch for correction to the stopped software TG after the node N2 is executed. The improvement system node applies a correction file (also referred to as a patch file) to operation target software and executes processes to improve the software.

A node N4 is a start system node to start the software TG to which the correction patch is applied after the node N3 is executed. The start system node transmits a start instruction command to the operation target server or software and executes the start process on the operation target server or software. Also, the start system node restores a snapshot of the operation target server.

A node N5 is an activity node which accepts an operation from an operator after the node N4 is executed. This operation is to select any one of an improvement process or stop process.

A node N6 is an improvement system node to apply a second patch for correction for the software TG when the operation to select the improvement process is accepted in the node N5.

A node N7 is an identification node indicating that the Automated Operation Process is normally terminated.

A node N8 is a stop system node to stop the software TG when the operation to select the stop process is accepted in the node N5.

A node N9 is an identification node indicating that the Automated Operation Process is normally terminated.

A node N10 is an inspection system node for inspecting a cause when an application of a patch for correction has failed in executing the node N3. The inspection system node executes a process of acquiring a log file of inspection target software, a process of managing or acquiring an event to be notified by the inspection target software, and a process of acquiring a file stored in the server in which the inspection target software is installed.

An erroneous termination node N11 is an identification node indicating that the Automated Operation Process is abnormally terminated.

The Automated Operation Process described in FIG. 3 is executed, so that the nodes of the Automated Operation Process are sequentially executed in the order expressed by arrows and the purpose of the Automated Operation Process is achieved.

The nodes described in FIG. 3 are stored in the storage 12 in the XML format, for example. The nodes are stored in the storage 12 as information including an identifier, name, and type of node, information about the operation target server or installed software, processes on the operation target, and identifiers of nodes to be connected before and after the node.

The storage 12 in FIG. 2 stores various Automated Operation Processes which are different from the Automated Operation Process described in FIG. 3.

### (Display of Automated Operation Process)

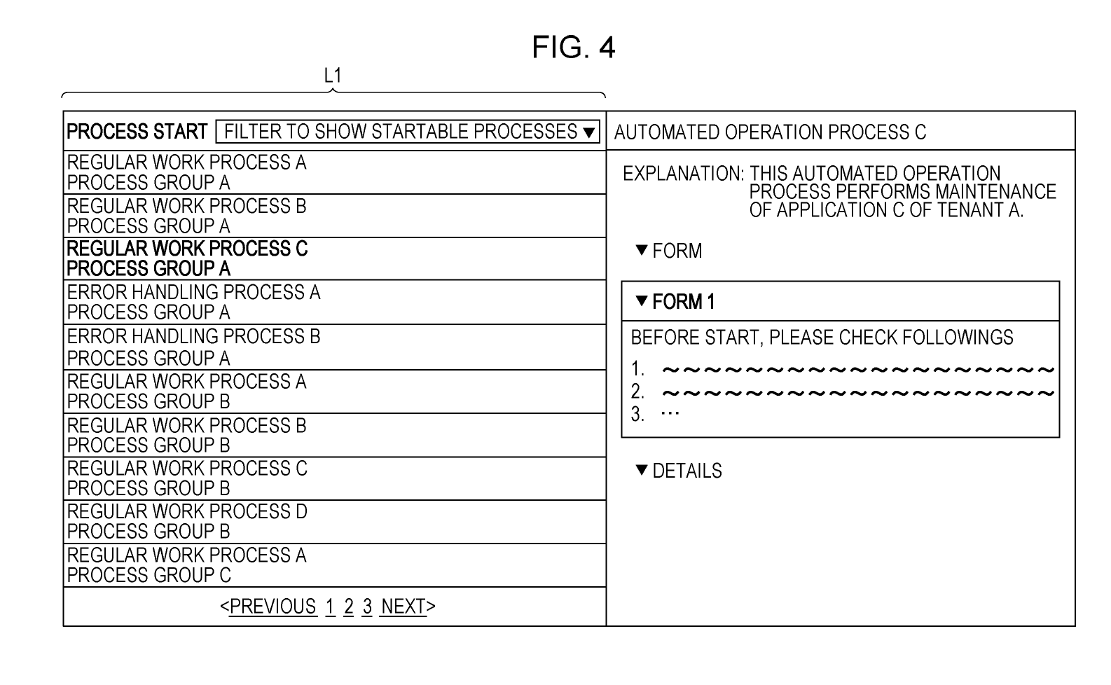

FIG. 4 is a diagram illustrating an example display of the Automated Operation Process. The example display of FIG. 4 is displayed on a display screen of the client terminal 2.

An operator (hereinafter expressed as an operator X as appropriate) of the information processing system transmits a display instruction command of the Automated Operation Process to the management server 1 by operating the client terminal 2. This display instruction command includes an identifier (also referred to as an ID number) of the operator X, for example.

When the control unit 131 of the management server 1receives this display instruction command, the control unit 131 acquires from the storage 12 multiple Automated Operation Processes in which the operator X has an authority to start. Then, the control unit 131 creates display data for displaying the information about the acquired multiple Automated Operation Processes in a list format and transmits the data to the client terminal 2. The display data is, for example, data in a hypertext markup language (HTML) format.

For example, the information about the Automated Operation Process is a name of the Automated Operation Process. This information may be a description of the Automated Operation Process.

The client terminal 2 displays the received display data in a display device (not illustrated) as illustrated in FIG. 4.

In FIG. 4, as illustrated by reference numeral L1, the name of the Automated Operation Process is displayed in a list format. For example, the names of the Automated Operation Processes, such as “regular work process A”, “regular work process B”, and “regular work process C” are displayed in the list format.

A number of the Automated Operation Processes in which the operator X has an authority to start are displayed without regularity. Accordingly, it is difficult for the operator X to find a desired Automated Operation Process from such a large number of Automated Operation Processes.

Here, in the case where the Automated Operation Processes are classified according to purposes to be achieved by the Automated Operation Processes and the classified Automated Operation Processes are displayed, it becomes easier for the operator X to find the Automated Operation Process matching the purpose that the operator X desires to achieve. This purpose corresponds to the type (for example, the “stop system”, “start system”, “improvement system”, or “inspection system”) described in FIG. 3. For example, the purpose of the Automated Operation Process is the stop (system is herein omitted) indicates that this Automated Operation Process has a stop process on an operation target, as a main purpose.

However, a developer of Automated Operation Processes develops a great variety of Automated Operation Processes according to various kinds of operation works, network configurations, and system configurations. Also, since the Automated Operation Process depends on a way how the developer creates it, even an Automated Operation Process with a same purpose, each developer develops their own Automated Operation Processes which vary depending on the developers. In other words, the Automated Operation Processes have a great variety. Also, the number of the Automated Operation Processes that the operator X has an authority to start is large.

Since there are many variations and many Automated Operation Processes as described above, it is difficult to classify the Automated Operation Processes according to the purposes by carefully and manually examining the contents of the Automated Operation Processes.

Also, the contents of the Automated Operation Process are complex. For example, in the case of the Automated Operation Process with the purpose to stop, the contents of the Automated Operation Process are complex. For example, the operation part for the purpose to stop is connected in front or behind to a node for stop confirmation, is connected in behind to a standby node, or a loop of nodes for check and stop is iterated. It is to be noted that a standby node is a node for standby until the fact that the stop has to be executed is confirmed.

Also, since the developer can update the created Automated Operation Process, the purpose of the Automated Operation process before the update and the purpose of the Automated Operation Process after the update may differ from each other.

Accordingly, it is more difficult to manually classify the Automated Operation Processes according to purposes.

Therefore, the management server according to the embodiment automatically allows the Automated Operation Processes to be classified according to the purposes to be achieved by the Automated Operation Processes and allows the classified Automated Operation Processes to be displayed. Furthermore, the management server allows the Automated Promotion Processes to be displayed such that the operator may highly efficiently find the Automated Operation Process to execute the process on the operation target which is designated by the operator.

### (Display Process Flow of Automated Promotion Process)

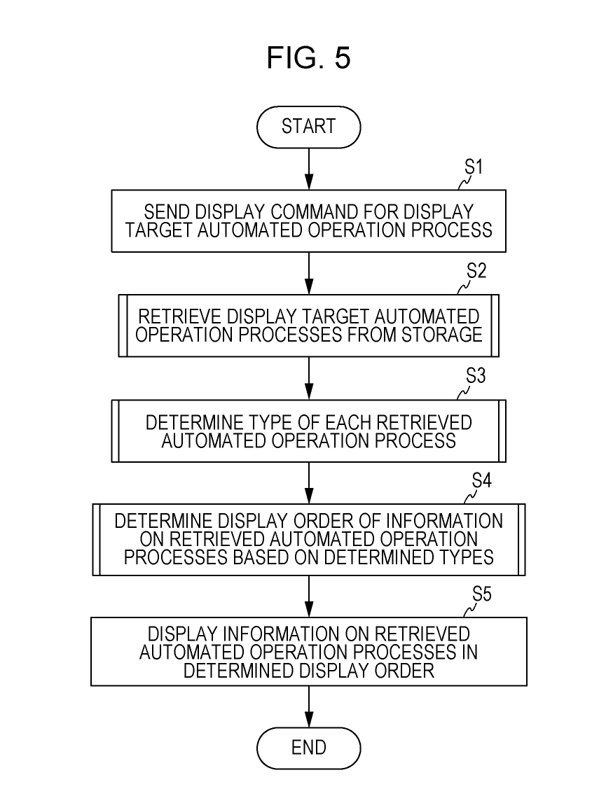

FIG. 5 is an example flowchart schematically illustrating a display process flow of the Automated Operation Process according to the embodiment.

Hereinafter, an Automated Operation Process which an operator has an authority to start is expressed as an authorized Automated Operation Process as appropriate. In addition, an Automated Operation Process to execute a process on an operation target which is designated by an operator is expressed as a display target Automated Operation Process as appropriate.

Step S1: An operator X sends a display command for a display target Automated Operation Process.

Specifically, the operator X inputs information specifying its own ID number and an operation target into the client terminal 2. For example, this information is an IP address and device name of the operation target device. The operation target which is designated by the operator is the sever 41 of the tenant A4 illustrated in FIG. 1, for example. For example, an error occurs in the server 41 and the operator X finds the Automated Operation Process executing a process on this server 41, and thereby handles the error.

The client terminal 2 transmits the display instruction command including the information specifying the ID number and the operation target to the management server 1.

Step S2: The list creation unit 133 of the management server 1 retrieves the display target Automated Operation Process from the storage 12. The list creation unit 133 retrieves multiple Automated Operation Processes executing a process on the operation target which is designated by the operator X from the multiple Automated Operation Processes stored in the storage 12. The retrieved Automated Operation Processes are Automated Operation Processes in which the operator X has an authority to start.

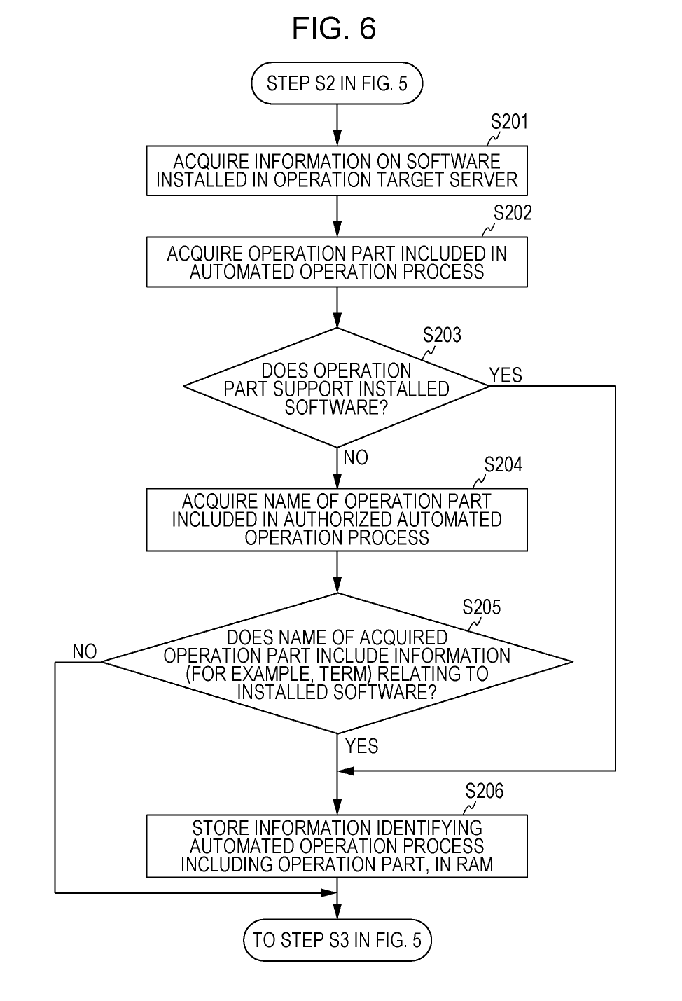

Specifically, a control unit 131 of the management server 1 receives the display instruction command and outputs the received display instruction command to the list creation unit 133. The list creation unit 133 retrieves the display target Automated Operation Process from the storage 12 based on the ID number of the operator X, information specifying the operation target, and the configuration information of the CMDB 14, which are included in the inputted display instruction command. Step S2 is described in detail in FIG. 6.

Step S3: The list creation unit 133 determines a type of each retrieved Automated Operation Process. Since the Automated Operation Process includes various types of processes (for example, operation parts) as described in FIG. 3, it is difficult to uniquely and manually determine the purpose of the Automated Operation Process. Thus, in order to automatically determine the type (purpose) of the Automated Operation Process, multiple processes in the Automated Operation Process are partitioned in units of the processes and thereby are divided into multiple groups, and the type of each of the divided groups is determined.

For example, the list creation unit 133 divides the multiple processes in the Automated Operation Process into multiple groups based on partition information (for example, a partition node to be described in FIG. 15A) indicating a partition of a unit of processes. Then, the list creation unit 133 determines the type of each of the groups based on processes (for example, operation parts) belonging to each of the divided groups.

Furthermore, the list creation unit 133 determines the type of this Automated Operation Process based on the determined type of each of the groups. Specifically, the type of the Automated Operation Process is an operation type of the entire process based on the Automated Operation Process.

Here, when the multiple Automated Operation Processes are retrieved at step S2, the list creation unit 133 executes the following processes in the divided groups.

In other words, the list creation unit 133 divides the multiple processes (for example, operation parts) in each retrieved Automated Operation Process into groups. The list creation unit 133 determines the type of each of the groups in each retrieved Automated Operation Process based on the processes belonging to the group in the retrieved Automated Operation Process. The list creation unit 133 determines the type of each retrieved Automated Operation Process based on the types of the groups in the retrieved Automated Operation Process.

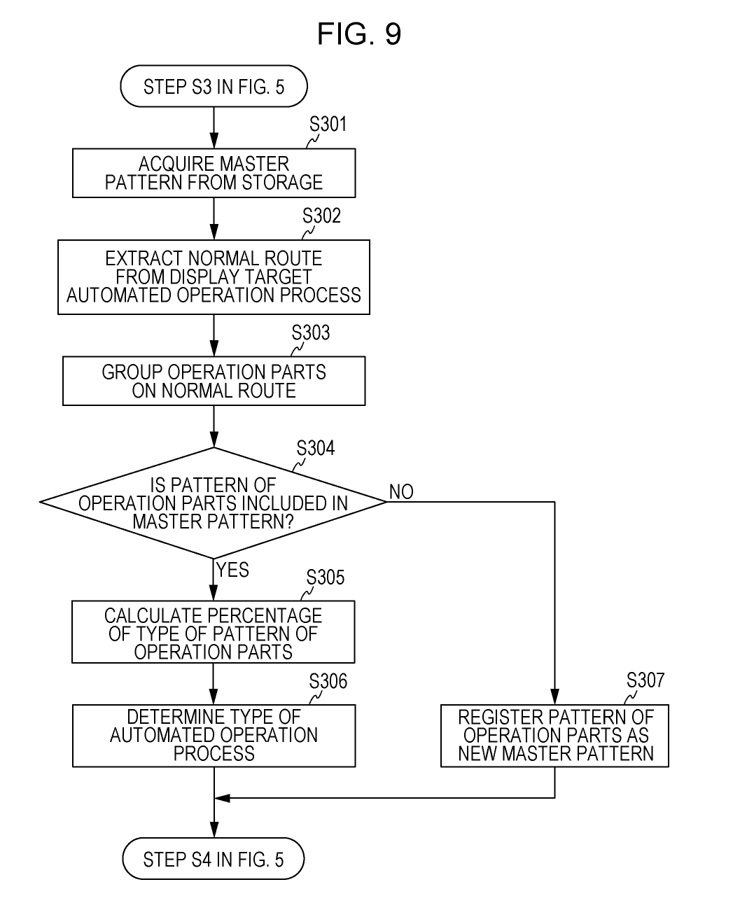

Step S3 is described in detail in FIG. 9.

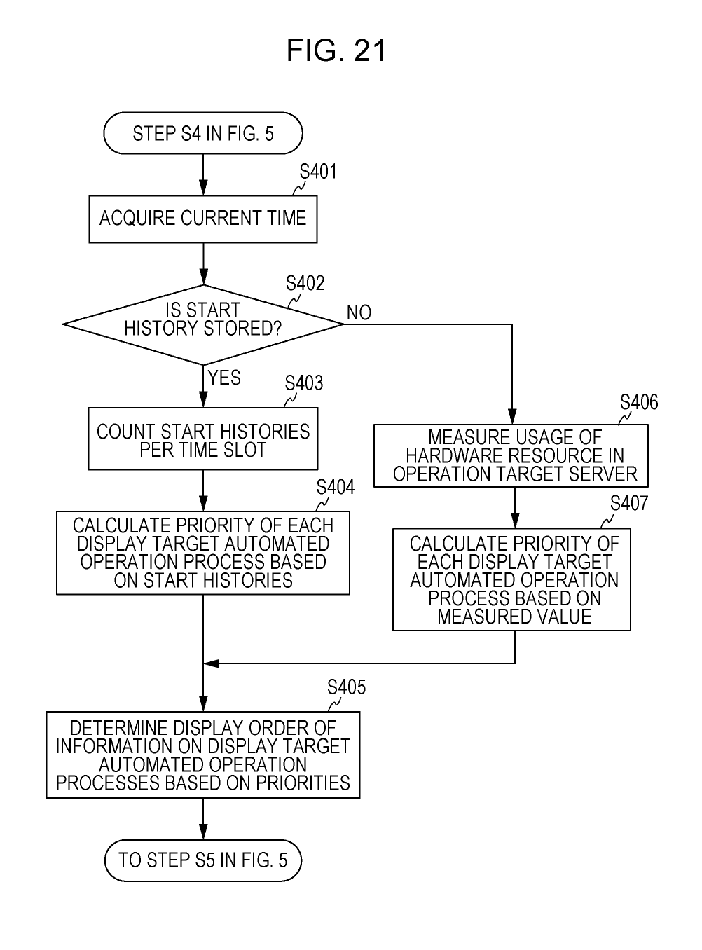

Step S4: The list creation unit 133 classifies the Automated Operation Processes based on the determined types of the Automated Operation Processes and determines the order of displaying information about these Automated Operation Processes. In this manner, the Automated Operation Processes are classified based on the types of the Automated Operation Processes, so that it becomes easier for the operator X to find the Automated Operation Process that the operator X desires to execute. Step S4 is described in detail in FIG. 21.

Step S5: The client terminal 2 displays information about the retrieved Automated Operation Processes in the determined display order. Specifically, the list creation unit 133 of the management server 1 creates display data to display the display target Automated Operation Processes in the determined display order and transmits the display data to the client terminal 2. The client terminal 2 displays the display data on the display device (not illustrated).

### (Retrieve of Display Target Automated Operation Process)

The retrieve process of the display target Automated Operation Process is described by referring to FIGS. 6 to 8.

FIG. 6 is an example flowchart illustrating a process flow of retrieving the display target Automated Operation Process in step S2 in FIG. 5.

Step S201: The list creation unit 133 makes an access to the CMDB 14 and acquires information about software installed in the operation target server. As described in FIG. 2, the CMDB 14 stores information (for example, a name and term) about software installed in the operation target server.

Hereinafter, the list creation unit 133 executes step S202 and processes after step S202 about an operation part included in each Automated Operation Process with an authority of the operator X.

Step S202: The list creation unit 133 acquires an operation part included in the authorized Automated Operation Process.

Specifically, the list creation unit 133 retrieves the Automated Operation Process with an authority of the operator X from the storage 12. The retrieve method includes various methods. For example, the first Automated Operation Process AP1 to the n-th Automated Operation Process APn, which are stored in the storage 12, include ID numbers of the operator X and other operators. In this case, the list creation unit 133 retrieves the Automated Operation Process including the ID number of the operator X from the first Automated Operation Process AP1 to the n-th Automated Operation Process APn.

The list creation unit 133 acquires the operation part included in each of the authorized Automated Operation Processes. An operation part is a node to perform a certain operation on the operation target described in FIG. 3, and the operation parts are the nodes N2, N3, N4, N6, N8, and N10 in the example of FIG. 3. For example, in the case where the authorized Automated Operation Processes are the first Automated Operation Process AP1 to the 100th Automated Operation Process AP100, the list creation unit 133 acquires an operation part included in each Automated Operation Process from each Automated Operation Process.

Step S203: The list creation unit 133 determines whether or not the operation part included in the retrieved Automated Operation process is an operation part supporting software installed in the operation target server (hereinafter, expressed as installed software as appropriate). The operation part supporting the installed software is an operation part executing any process (for example, stop, start, improvement, inspection, or state acquisition) on this software.

In the case of YES at step S203, the process proceeds to step S206. In the case of NO at step S203, the process proceeds to step S204.

Step S204: The list creation unit 133 acquires the name of the operation part included in the retrieved Automated Operation Process. The name of the operation part is also a name of the node. The name of the operation part is the “stop work unit” of the node N2 in FIG. 3, for example.

Step S205: The list creation unit 133 determines whether or not the name of the acquired operation part includes information about the installed software. This information is, for example, a term which is determined in advance corresponding to the installed software. The details are described in FIG. 8.

When the name of the operation part included in the retrieved Automated Operation Process includes the information about the installed software (S205/YES), the process proceeds to step S206. When the name does not include the information (S205/NO), the process is not performed.

Step S206: The list creation part 133 stores information specifying the Automated Operation Processes including the operation parts described at step S203 and step S205 in the RAM 13. The operation part described at step S203 is an operation part supporting software installed in the operation target server. The operation part described at step S205 is an operation part having a name including the information about software installed in the operation target server (for example, a term of the software). The information specifying the Automated Operation Process is an identifier of the Automated Operation Process, for example.

### (Specific Example of Retrieve Process)

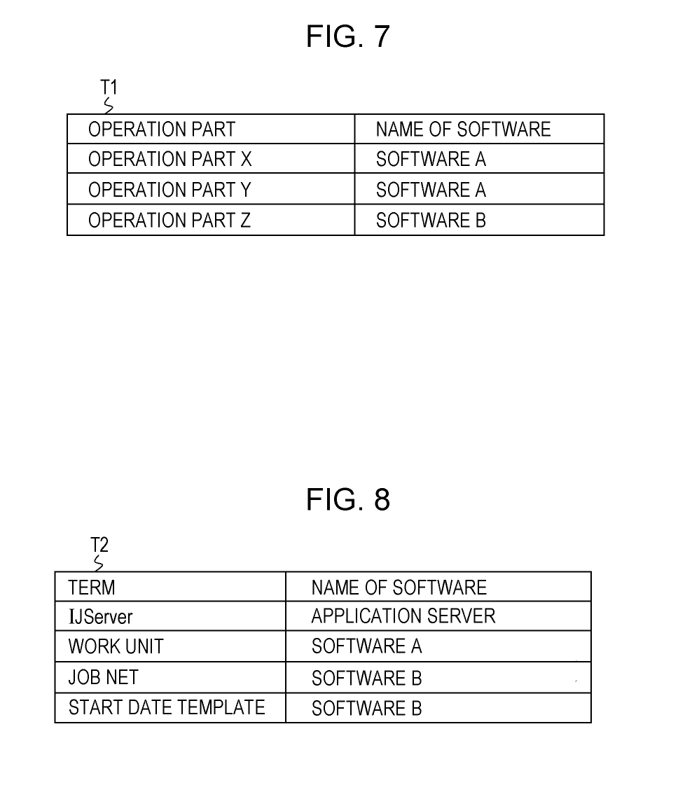

Referring to FIGS. 7 and 8, the retrieve process of the display target Automated Operation Process described in FIG. 6 is described more specifically. FIGS. 7 and 8 are diagrams, each illustrating an example table which is referred to in retrieving the display target Automated Operation Processes.

FIG. 7 is a diagram illustrating an example table storing the identifiers of the operation parts and the names of software corresponding to the operation parts.

An operation target software table T1 stores names of software which is determined in advance for each Automated Operation Process and is used as an operation target by the operation part of this Automated Operation Process. It is to be noted that each of the first Automated Operation Process AP1 to the n-th Automated Operation Process APn, which are illustrated in FIG. 2, may include a table having a format same as that of the operation target software table T1 and may include the name of software which is used by the operation part of the Automated Operation Process as an operation target.

The column of operation part stores an identifier to uniquely identify the operation part. The column of name of software stores names of software which is an operation target and is used by the operation part with the identifier stored in the column of identifiers of the operation parts. The operation target software table T1 stores the identifiers of the operation parts and the names of software corresponding to these operation parts in the same row.

FIG. 8 is a diagram illustrating an example table storing terms of software and the names of the software.

An operation target term table T2 is determined in advance for each of the Automated Operation Processes and stores terms of software which is used as an operation target by the operation part of this Automated Operation Process and the names of operation target software. It is to be noted that each of the first Automated Operation Process AP1 to the n-th Automated Operation Process APn, which are illustrated in FIG. 2, may include a table having a format same as that of the operation target term table and may store terms and names of software which is used as an operation target by the operation part of the Automated Operation Process.

The column of term in the operation target term table T2 stores the terms which are determined in advance corresponding to the software. The column of the software name stores the names of software. The operation target term table T2 stores the name of the software and the term determined in advance for this software in the same row.

The first Automated Operation Process AP1 to the n-th Automated Operation Process APn, which are described in FIG. 2, are stored in, for example, the storage 12 corresponding to first specific information to specify the software installed in the operation target server. This first specific information is the tables in FIGS. 7 and 8, for example.

The list creation unit 133 acquires second specific information to specify the software installed in the designated operation target server (S201). This second specific information is configuration information stored in the CMDB 14 and is, for example, information about software installed in the designated operation target server (for example, the name of software).

In the following description, as described in FIG. 5, the designated operation target server is the server 41 of the tenant A4 illustrated in FIG. 1.

The list creation unit 133 makes an access to the CMDB 14 and acquires “software A” and “software B” as the configuration information (for example, names) of software installed in the server 41 (S201).

The list creation unit 133 acquires the operation parts (for example, the nodes N2 and N3) included in the authorized Automated Operation Process (for example, the Automated Operation Process in FIG. 3) (S202).

The list creation unit 133 determines whether or not the identifier of the operation part of the authorized Automated Operation Process and the name of installed software acquired at step S201 are stored in the same row in the operation target software table (for example, the operation target software table in FIG. 7) which is determined in advance for the authorized Automated Operation Process (S203).

In the above-described example, the identifier of the operation part included in the authorized Automated Operation Process is an “operation part X”. The name of installed software acquired at step S201 is a “software A”.

The identifier “operation part X” and the name “software A” are stored in the same row in the operation target software table T1. Accordingly, the list creation unit 133 determines YES at step S203 and the process proceeds to step S206.

In other words, the list creation unit 133 retrieves the Automated Operation Process, as a display target Automated Operation Process, which corresponds to the first specific information matching the second specific information to specify the software installed in the designated operation target server.

The list creation unit 133 stores the information (for example, the name, identifier) specifying the retrieved display target Automated Operation Process in the RAM 13 (S206).

On the other hand, when the type and the name are not stored in the same row in the operation target software table T1 in the determination at step S203 (S203/NO), the process proceeds to step S204.

The list creation unit 133 acquires the names of operation parts included in the authorized Automated Operation Process (S204). This name is the “stop work unit” of the node N2 in FIG. 3, for example.

The list creation unit 133 determines whether or not a word included in the name of the operation part included in the authorized operation process and the name of software, which is acquired at step S201, are stored in the same row in the operation target term table determined in advance for the authorized Automated Operation Process (S205). This operation target term table is the operation target term table T2 in FIG. 8, for example.

The words included in the name of the operation part are “work unit” and “stop”. Then, the names of software, which are acquired at step S201, are the “software A” and the “software B”.

This word (term) “work unit” and the name of software “software A” are stored in the same row of the operation target term table T2. Accordingly, the list creation unit 133 determines YES at step S205, and the process proceeds to step S206.

In other words, the list creation unit 133 retrieves the Automated Operation Process, as a display target Automated Operation Process, which corresponds to the first specific information matching the second specific information specifying the software installed in the designated operation target server.

The list creation unit 133 stores information specifying the retrieved display target Automated Operation Process in the RAM 13 (S206).

The list creation unit 133 executes the processes of step S202 and thereafter on all the authorized Automated Operation Processes, and then executes the process at step S3 in FIG. 5.

### (Type Determination for Retrieved Automated Operation Process)

FIG. 9 is an example flowchart illustrating a process flow of determining a type of the retrieved Automated Operation Process at step S3 in FIG. 5.

Step S301: The list creation unit 133 acquires a master pattern MP from the storage 12 and runs it in the RAM 13.

Step S302: The list creation unit 133 extracts a normal route from the display target Automated Operation Process. The list creation unit 133 executes the processes of step S302 and thereafter for each of the display target Automated Operation Processes. For example, when there are 100 display target Automated Operation Processes, the list creation unit 133 executes the processes of step S302 and thereafter for each of the 100 Automated Operation Processes.

Step S303: The list creation unit 133 groups the operation parts on the normal route in the display target Automated Operation Process.

Step S304: The list creation unit 133 determines whether or not a pattern of the operation parts grouped at step S303 is included in the master pattern MP. When it is included (S304/YES), the process proceeds to step S305.

Step S305: The list creation unit 133 determines a type of the pattern of the grouped operation parts and calculates a percentage of the type in the Automated Operation Process including the grouped operation parts.

Step S306: The list creation unit 133 determines the type of the Automated Operation Process based on the percentage of the type in the Automated Operation Process including the grouped operation parts. The list creation unit 133 determines the type of this Automated Operation Process to be the type with the highest percentage in determining the type of the Automated Operation Process.

When the list creation unit 133 determines at step S304 that the pattern of the operation parts grouped at step S303 is not included in the master pattern MP (S304/NO), the process proceeds to step S307.

Step S307: The list creation unit 133 registers the pattern of the operation parts grouped at step S303 as a new master pattern in the storage 12. For example, at this time, an administrator of the information processing system may determine a type of the new master pattern.

### (Master Pattern)

FIGS. 10A to 14 are first to fifth diagrams, each illustrating a master pattern which is referred to when a type of Automated Operation Process is determined. The master pattern is a set of operation parts in series performing a process on a specific operation target (for example, installed software).

FIGS. 10A and 10B are diagrams for illustrating a master pattern. Hereinafter, in FIGS. 10A to 14, an operation part is expressed by a square with a solid line. The type of this operation part is expressed by words in the square with the solid line. Connection information of the operation parts is expressed by an arrow between the squares with the solid line.

The master pattern is stored in the storage 12 of the management server 1 as a master pattern MP by an administrator of the information processing system, for example, in the initial state.

The type of the master pattern is determined based on the type of the operation part, the combination between the operation parts, and the execution order of the operation parts (see arrows in FIGS. 10A to 14).

It is to be noted that when the number of the operation parts is 1 (a single part), the type of the operation part and the type of the master pattern are equal to each other.

FIG. 10A is a diagram illustrating a master pattern in which the operation parts having a same type are continuous. As illustrated in FIG. 10A, when the operation parts having the same type are continuous, the continuous operation parts are gathered together and regarded as one operation part. For example, when three operation parts each having a type of “XX” continue, the three operation parts are regarded as one operation part having a type of “XX” (see an arrow from the left to right in FIG. 10A).

FIG. 10B is a diagram illustrating a basic master pattern (hereinafter, expressed as a basic pattern) and a master pattern which is derivative from the basic pattern (hereinafter, expressed as a derivative pattern). In the following description, the basic pattern of the master pattern are illustrated with a dotted frame. In FIG. 10B, three master patterns are illustrated as basic patterns.

The derivative pattern is, for example, a pattern in which multiple operation parts in the basic pattern are replaced by operation parts in the other basic pattern. For example, the master pattern illustrated by a dotted-chain line is regarded as an operation part of the type “XX”. Then, the master pattern illustrated by the dotted-chain line replaces the operation part with the type “XX” in the master pattern illustrated by a two-dotted chain line, which is then newly defined as a derivative pattern illustrated by a broken line. It is to be noted that an administrator may add a derivative pattern as desired. In the following description, the derivative pattern is illustrated by a broken line.

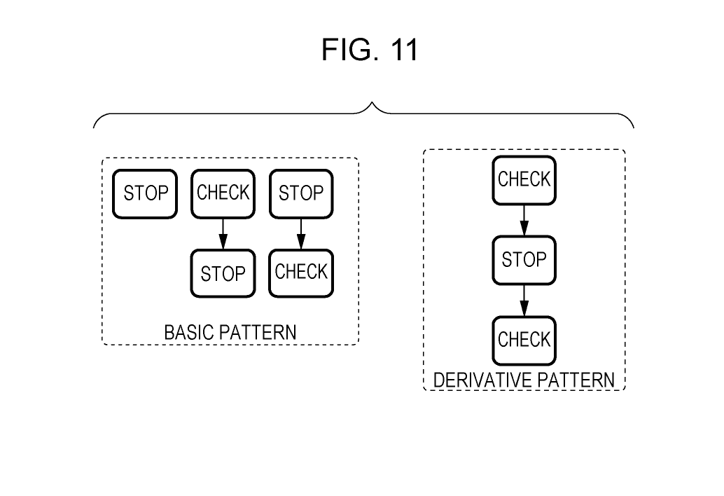

FIG. 11 is a diagram schematically illustrating a master pattern having a type of the stop system. Here, the operation part having a type of a state check system does not affect the operation target by itself and plays a backup role for the operation part used at the same time. Therefore, when the operation part with the type of the stop system is used together with the operation part with the type of the check system, it is assumed that the type of the master pattern is a stop system.

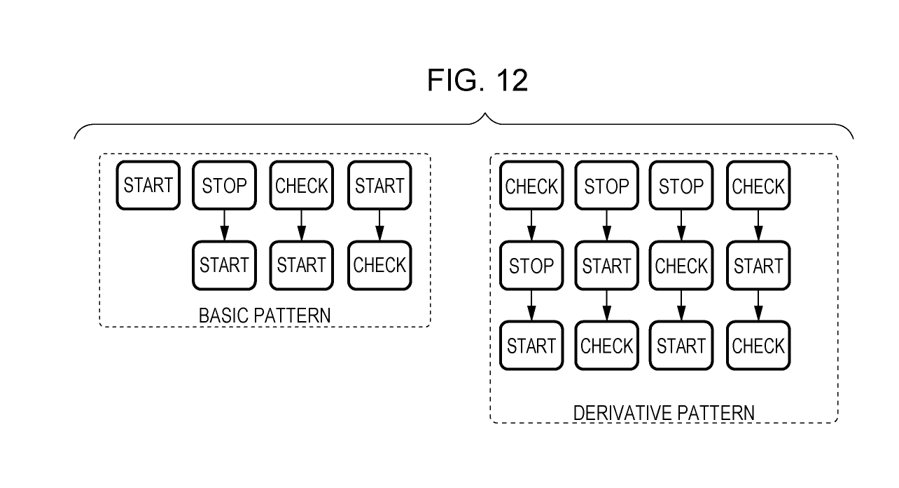

FIG. 12 is a diagram schematically illustrating a master pattern of the start system. Here, the operation part with the type of the state check system does not affect an operation target by itself and plays a role as a backup role for the operation part used at the same time. Therefore, when the operation part with the type of the start system is used together with the operation part with the type of the check system, it is assumed that the type of the master pattern is a start system. Also, when the operation part with the type of the start system is connected after the operation part with the type of the stop system, these operation parts may be regarded as a restart operation (in other words, a restart system) as a whole (entire pattern). Since the restart operation is an operation for normally starting a server or an application (service), it is assumed the type of the master pattern including these operation parts is a start system.

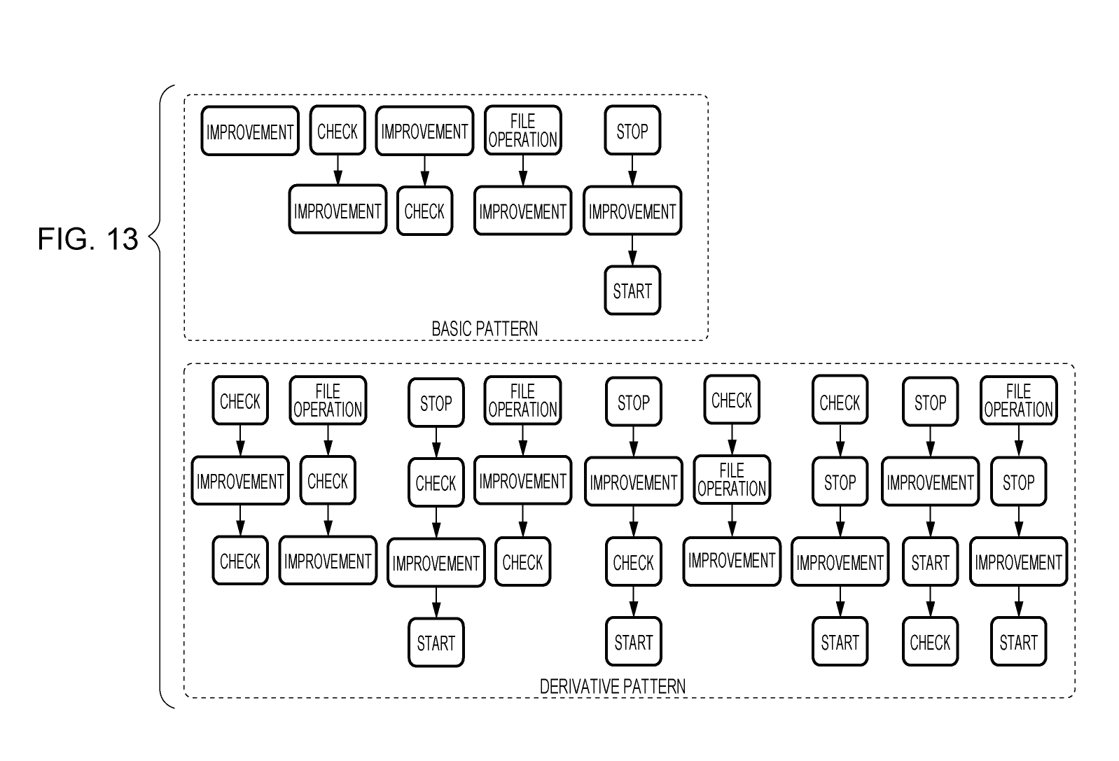

FIG. 13 is a diagram schematically illustrating a master pattern with the type of the improvement system. Here, when the master pattern of the restart system and the operation part with the type of the improvement system are used together, the restart process is a process to reflect an improvement of a server or service (such as a change in settings), and thus it is assumed that the type of the master pattern including these operation parts is an improvement system.

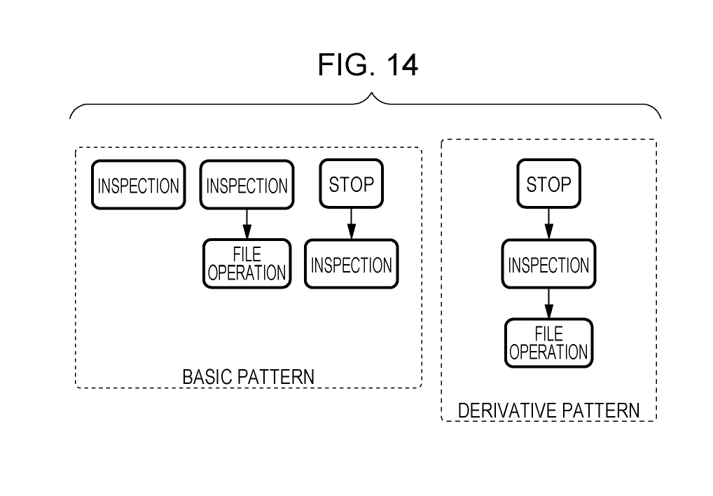

FIG. 14 is a diagram schematically illustrating a master pattern with the type of the inspection system. It is assumed that the type of the master pattern including the operation part with the type of the inspection type is an inspection system.

As illustrated in FIGS. 11 to 14, the type of the master pattern (for example, the “stop system”, “start system”, “improvement system”, or “inspection system”) indicates a type of one or more patterned operation parts.

The type of the patterned operation parts described in FIGS. 11 to 14 and connection information of the operation parts are stored in the storage 12 as the master pattern MP. The list creation unit 133 acquires the master pattern MP from the storage 12 and runs it in the RAM 13.

### (Grouping of Operation Parts)

FIGS. 15A to 15D are diagrams illustrating a process of grouping the operation parts on the normal route in the display target Automated Operation Process at step S303 in FIG. 9. In FIG. 15A to 15D, nodes are illustrated by a square frame and a rhomboid frame. A start node, a normal termination node, and an erroneous termination node are illustrated by a circle frame. Also, connection information between the nodes is expressed by arrows. Here, the arrows indicate the node execution order.

FIG. 15A is a diagram illustrating an example Automated Operation Process. The Automated Operation Process is a display target Automated Operation Process, for example. The list creation unit 133 extracts a route of a series of nodes connected between the start node and the normal termination node as a normal route in the display target Automated Operation Process (S302).

The route from the start to the erroneous termination is not directly related to the type of the entire Automated Operation processes, and therefore is excluded from the route which is referred to when determining the type of the Automated Operation Process.

In the example of FIG. 15A, the list creation unit 133 extracts the route of a series of nodes connected between the start node and the node of the normal termination 1 as a first normal route (see a thin dotted arrow). Then, in the example of FIG. 15A, the list creation unit 133 extracts the route of a series of nodes connected between the start node and the node of the normal termination 2 as a second normal route (see a thick dotted arrow).

FIG. 15B is a diagram illustrating a process of extracting a partition node. There is a case where multiple types of processes are included in the series of processes on the normal route. For example, the multiple types are the type of the strop system, the type of the start system, and the type of the improvement system. Thus, in the series of processes on the normal route, multiple processes are partitioned.

The partition node is a node which is a reference when a unit of process is partitioned. The partition node is one example of the second node which is the partition information indicating a partition of a unit of the processes expressed by one or more first nodes (operation parts) described in FIG. 3.

In FIG. 15B, the node illustrated by vertical hatching is a partition node. The list creation unit 133 extracts the partition node from the nodes on the extracted normal route as illustrated by the dotted line in FIG. 15B.

There are following four partition nodes, for example.

A first node is a node in which a human determination is requested.

For example, the first node is an activity node or a voting node. The node in which a human determination is requested is a node which a person is requested to check an execution result and determine whether or not the process is properly performed. When a human determination is requested, a series of processes indicated by a series of nodes partitioned by a partition node may be regarded as completed (process end). Accordingly, the node in which a human determination is requested is set to be a partition node.

A second node is a node for standby between a series of processes (operations) and a series of processes (operations) on an operation target. For example, the second node is a node of standby at an absolute time. The node of standby at an absolute time is used for waiting for a regular work, and the processes before this node do not continue when waiting for a work. Accordingly, the series of processes indicated by the series of the nodes partitioned by this type of partition node may be regarded as completed. Thus, a node of standby between a series of processes and a series of processes on an operation target may be set to a partition node.

A third node is a node which executes another process (sub-process) in the node. For example, the third node is a sub-process node. The sub-process is a process relating to (linking with) another work (another Automated Operation Process), and the processes before this node do not continue. Accordingly, the node executing another process in the node is set to be a partition node.

A fourth node is a node which performs no process on an operation target. The operation target in the fourth node is not a server or an application (service) installed in the server. For example, the fourth node is a node which performs transmission and reception of mails, date operation, or an operation for a character string such as an execution result. The node which performs no process on an operation target does not request a human determination, but is a node which outputs whether or not the process is properly performed. Accordingly, the series of processes indicated by the series of nodes partitioned by this type of partition node may be regarded as completed. Thus, the node which performs no process on the operation target is set to be a partition node.

As described above, the list creation unit 133 divides the multiple first nodes (for example, the operation parts) in the display target Automated Operation Processes into groups by using the partition node as a reference.

FIG. 15C is a diagram illustrating a process of excluding a node to be ignored. Among the partitioned nodes, there is a node which does not relate to the process on the operation target (hereinafter, expressed as a node to be ignored) except the partition node described in FIG. 15B. In FIG. 15C, nodes illustrated with the horizontal hatching are nodes to be ignored.

The node to be ignored may be ignored in determining the type of Automated Operation Process. Accordingly, the list creation unit 133 excludes the node to be ignored from the partitioned nodes in order to improve process efficiency in the determination process.

For example, the node to be ignored includes a node to wait for completion of the start/stop process or node to determine an execution result. For example, the node to wait for completion of the start/stop process is a node to stand by at a relative time. The node to wait for completion of the start/stop process is a node to wait for a period therebetween, which may be regarded as the process on the operation target continuing. Thus, the node to wait for completion of the start/stop process may be regarded as a node to be ignored.

For example, the node to determine an execution result (see the rhomboid frame) is a logic node. The logic node is a node to wait for multiple processes executed by the multiple nodes connected before the logic node. Also, the logic node is a node to branch to any of multiple nodes connected after the logic node based on the result of the process executed by the nodes connected before the logic node.

The node to determine an execution result is a node to be executed by a following node by referring the result executed by the node connected before the node, which is different from the node in which a human determination is requested. The process on the operation target may be regarded as continuing. The node to determine an execution result is set to be a node to be ignored.

The list creation unit 133 excludes the node to be ignored from the partitioned nodes and groups the operation parts in which the node to be ignored is excluded (S303).

FIG. 15D schematically illustrates grouping of the operation parts. The grouped operation parts are multiple partitioned operation parts in which the node to be ignored has been already excluded. The grouped operation parts are illustrated by dotted frames.

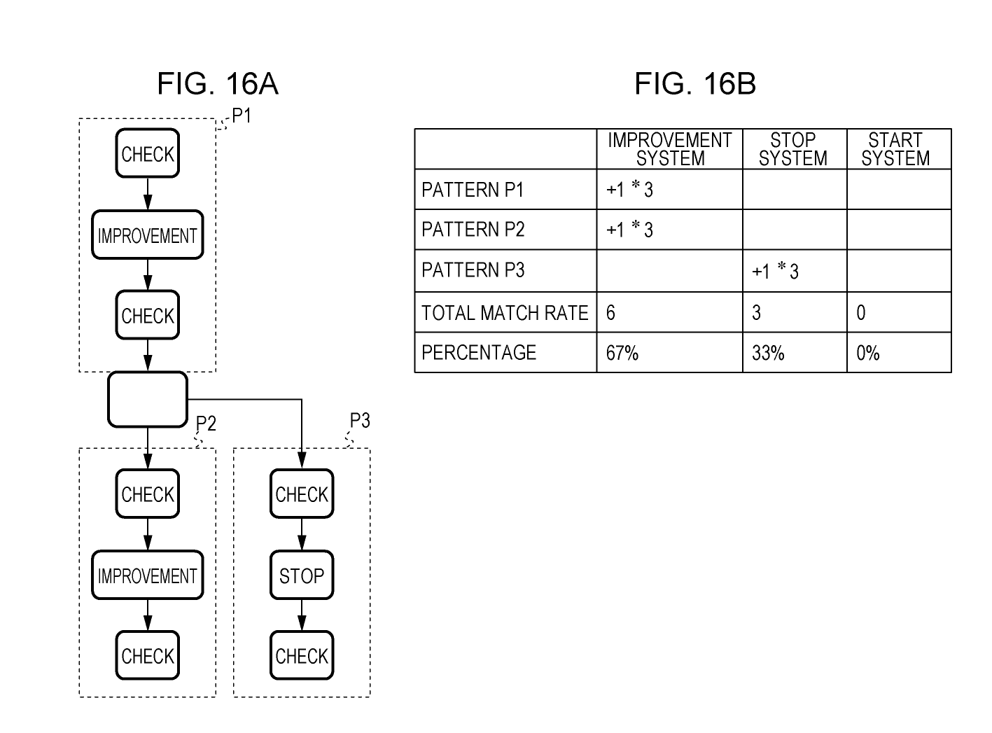

The list creation unit 133 determines whether or not the pattern of the grouped operation parts is included in the master patterns described in FIGS. 11 to 14 (S304). The pattern of the grouped operation parts has the same meaning as the type of the entire grouped operation parts. The specific example of the determination is described in FIG. 16.

### (Type Determination for Automated Operation Process)

Referring to FIGS. 11, 13, and 16A to 18B, the type determination for the Automated Operation Process is specifically described. FIGS. 16A and 16B are diagrams (first) specifically illustrating the type determination for the Automated Operation Process. FIG. 16A is a diagram illustrating the grouped operation parts described in FIG. 15A to 15D. The series of the operation parts illustrated by the dotted frames indicated by reference numerals P1 to P3 are the grouped operation parts.

The list creation unit 133 determines the type of each of the groups in this Automated Operation Process before the type determination for the Automated Operation Process. Specifically, the list creation unit 133 compares the master patterns MP (see FIGS. 11 to 14) with the type of one or more operation parts in the group. For example, the master patter MP is an example of type information indicating the type of the one or more patterned operation parts.

Then, the list creation unit 133 determines that the type of the group is the type of the one or more grouped operation parts which matches the type of the one or more operation parts in this group.

In the example of FIG. 16, the group is a set of operation parts indicated by the patterns P1, P2, and P3.

In the patterns P1 and P2, the check system operation part, the improvement system operation part, and the check system operation part are connected in this order. The patterns P1 and P2 are included in the derivative pattern in the improvement system master pattern described in FIG. 13. Accordingly, the list creation unit 133 determines that the patterns P1 and P2 of the operation parts grouped at step S303 are included in the improvement system master pattern (S304/YES). Then, the list creation unit 133 determines the type of the patterns P1 and P2 as the improvement system.

In the pattern P3, the check system operation part, the stop system operation part, and the check system operation part are connected in this order. The pattern P3 is included in the derivative pattern in the stop system master pattern described in FIG. 11. Accordingly, the list creation unit 133 determines that the pattern P3 of the operation parts grouped at step S303 is included in the stop system master pattern (S304/YES). Then, the list creation unit 133 determines the type of the pattern P3 as the stop system.

As described above, using the master pattern to be a reference for determination, the type of group is determined. This master pattern is determined in advance for each of the types, and the number thereof is exceedingly smaller than the number of variations of the Automated Operation Processes. More specifically, a developer may infinitely increase variations of the Automated Operation Processes. In this case, when the type of the Automated Operation Process is fixed in advance for each of the Automated Operation Processes, in other words, a master pattern to be a reference for type determination is fixed for each of the Automated Operation Processes, a capacity to store the master patterns becomes enormous, which is not realistic. Also, this increases an amount of processes when the Automated Operation Process is compared with the master pattern.

However, the number of master patterns which is fixed for each of the types of the groups (for example, the improvement system) is only dozens. In the example of FIG. 13, the number of the improvement system master patterns is 14. Accordingly, the capacity to store the master patterns may be greatly reduced. Furthermore, the process amount when the group in the Automated Operation Process is compared with the master pattern may be suppressed.

The list creation unit 133 determines the most dominant type among the types of the groups in the display target Automated Operation Process (for example, the Automated Operation Process in FIG. 16A) in determining the type of the Automated Operation Process. Then, the list operation unit 133 determines that the type of the display target Automated Operation Process is the determined type. Here, the most dominant type is regarded as a main purpose (type) which is achieved by the Automated Operation Process.

Specifically, in determining the type of the Automated Operation Process, the list creation unit 133 determines the total number of operation parts in each of the groups as a score of the type of the group. Then, the list creation unit 133 determines that the type having the highest score is the type of the Automated Operation Process.

In the example of FIGS. 16A and 16B, the list creation unit 133 calculates the total number of all the operation parts in the patterns P1 to P3. The numbers of all the operation parts in the patterns P1 to P3 are “3” each.

Then, the list creation unit 133 calculates the total number of all the operation parts in the patterns having the same type as a total match rate. Then, the list creation unit 133 calculates a percentage of this type based on the total match rate (S305).

FIG. 16B is a table illustrating a process of calculating the percentage of the type. The list creation unit 133 stores the total number “3” (+1*3) of all the operation parts in the pattern P1 in a cell in which a row of the pattern P1 and a column indicating the type of the “improvement system” of the pattern P1 intersect each other. The list creation unit 133 stores the total number “3” (+1*3) of all the operation parts in the pattern P2 in a cell in which a row of the pattern P2 and a column indicating the type of the “improvement system” of the pattern P2 intersect each other. Then, the list creation unit 133 stores the total number “3” (+1*3) of all the operation parts in the pattern P3 in a cell in which a row of the pattern P3 and a column indicating the type of the “stop system” of the pattern P3 intersect each other.

The list creation unit 133 calculates the total number “6” (3+3) of all the operation parts in the patterns P1 and P2 having the same type of the improvement system as a total match rate. Then, the list creation unit 133 stores the calculated total match rate “6” in a cell in which a row indicating the total match rate and a column indicating the improvement system intersect each other.

Furthermore, the list creation unit 133 calculates the total number “3” of all the operation parts in the pattern P3 having the same type of the stop system as a total match rate. Then, the list creation unit 133 stores the calculated match rate “3” in a cell in which a row indicating the total match rate and a column indicating the stop system intersect each other.

The list creation unit 133 calculates a percentage of the type of the Automated Operation Process illustrated in FIG. 16A based on the calculated total match rate (S305).

In the unit of percentage, the list creation unit 133 calculates a ratio obtained by dividing the total match rate in each type with the total amount of the total match rates. Specifically, in the example of FIG. 16, the total amount of the total match rates is “9” (6+3). The list creation unit 133 calculates the improvement system as 67% ((6/9)×100). Then, the list creation unit 133 stores this calculated percentage “67%” in a cell in which a row indicating the percentage and a column indicating the improvement system intersect each other. Then, the list creation unit 133 calculates the stop system as 33% ((3/9)×100). Then, the list creation unit 133 stores this calculated percentage “33%” in a cell in which a row indicating the percentage and a column indicating the stop system intersect each other.

The list creation unit 133 determines the type “improvement system” with the highest percentage (66%) as the type of the Automated Operation Process illustrated in FIG. 16A (S306).

In other words, the list creation unit 133 determines the type having the highest total match rate in the Automated Operation Process as the type of this Automated Operation Process. The type having the highest total match rate is the most dominant type among the types of the groups in the Automated Operation Processes, and is, more specifically, the type having the highest score in the groups.

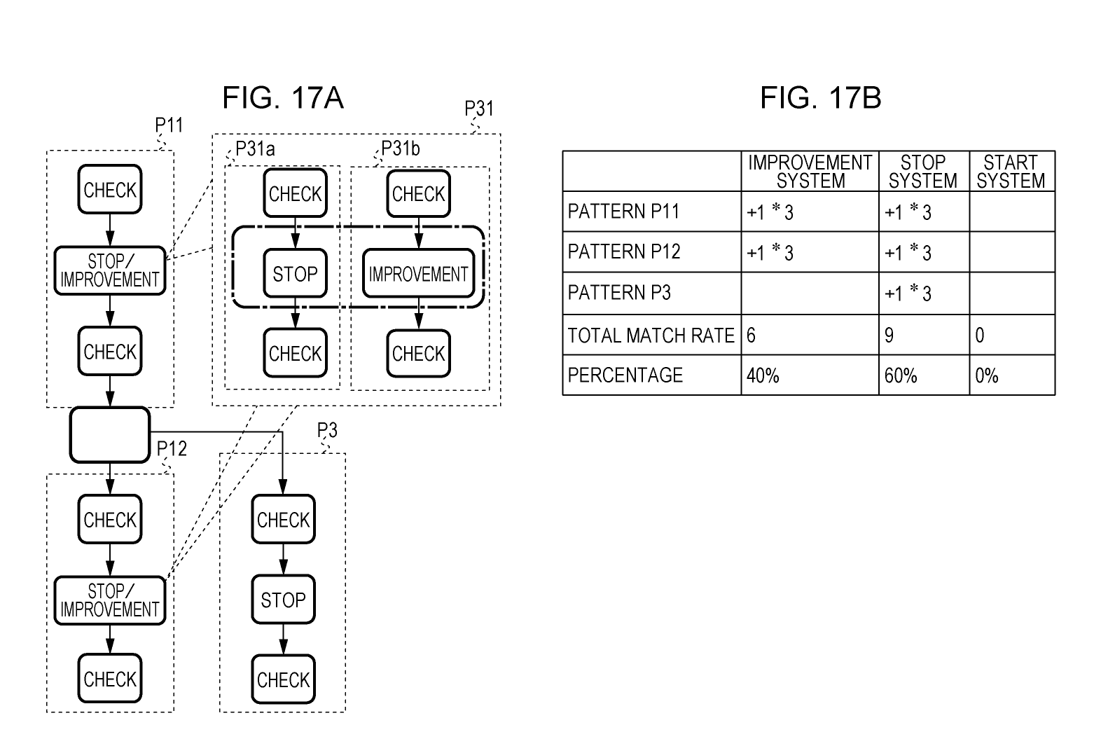

FIGS. 17A and 17B (second) and 18A and 18B (third) are diagrams specifically illustrating the type determination for the Automated Operation Process.

One operation part in the Automated Operation Process may execute a different type of process. In other words, the operation part having not only one type but also multiple types may be defined.

In other words, the operation part is any one of an operation part (node) having a single type including one process and one type of process or an operation part having multiple processes and multiple types indicating types of the multiple processes.

FIG. 17A is a diagram illustrating the grouped operation parts described in FIGS. 15A to 15B. In FIG. 17A, the operation parts indicated by the “stop/improvement” in the patterns P11 and P12 indicate operation parts capable of executing different types of processes (hereinafter, expressed as multi-process operation parts as appropriate). In FIG. 17A, the “improvement system” operation parts in the patterns P1 and P2 in FIG. 16A are replaced by the “stop/improvement” operation parts.

For example, the multi-process operation parts may execute the stop process and the improvement process on the same operation target. The multi-process operation part executes any one of the types of processes in response to an instruction from the operator or time in which the Automated Operation Process is executed.

For example, a time slot of working hours (for example, from 9:00 am to 6:00 pm), a first multi-process operation part executes a process of the improvement system on an operation target. Also, in a time slot other than the working hours (for example, from 6:00 pm to 9:00 am), the first multi-process operation part executes the stop system on an operation target.

In addition, in the time slot of the working hours, a second multi-process operation part executes a process of the inspection system on an operation target. In addition, in a time slot other than the working hours, the second multi-process operation part executes the improvement system on an operation target.

When the type of the Automated Operation Process including the multi-process operation part is determined, there are following two methods.

A first method is a method of comparing the type of the operation parts having a single type and the type of the operation parts having multiple types with the master pattern MP in the group when the group includes the operation parts having a single type and the operation parts having multiple types in determining the types of the groups. This group is a set of the operation parts illustrated by the patterns P11, P12 (P31a, P31b), and P3 in FIGS. 17A and 17B.

In other words, the first method is a method of calculating the total number of all the operation parts with regard to the type of all the processes which are executed by the multi-process operation part. A specific example of the first method is described by using FIGS. 17A and 17B. In the patterns P11 and P12, the list creation unit 133 regards the operation parts as being connected with each other to be illustrated in the patterns P11 and P12 below because it regards such that both the multi-process operation parts “stop/improvement” are executed.

In other words, the list creation unit 133 regards the patterns P11 and P12 as such that the check system operation part, the stop system operation part, and the check system operation part are connected in this order (see, the pattern 31a). Furthermore, the list creation unit 133 regards the patterns P11 and P12 as such that the check system operation part, the improvement system operation part, and the check system operation part are connected in this order (see, the pattern P31b).

Then, the list creation unit 133 determines if the patterns P31a and P31b are included in the master patterns in FIGS. 11 to 14. The pattern 31a is included in the derivative pattern in the stop system master pattern described in FIG. 11. Accordingly, the list creation unit 133 determines that the pattern P31a is the stop system. The pattern P31b is included in the derivative pattern of the improvement system master pattern described in FIG. 13. Accordingly, the list creation unit 133 determines that the pattern P31b is the improvement system.

After that, the list creation unit 133 determines that the types of the patterns P11 and P12 are the stop system and the improvement system. It is to be noted that the list creation unit 133 determines the type of the pattern P3 as the stop system as described in FIGS. 16A and 16B.

Then, the list creation unit 133 calculates the total number of all the operation parts in the patterns P11, P12, and P3. The total number of all the operation parts in the patterns P11, P12, and P3 are “3” each.

The list creation unit 133 calculates the total number of all the operation parts in the same pattern as the total match rate. Then, the list creation unit 133 calculates a percentage of this type based on this total match rate (S305).

FIG. 17B is a table illustrating the process of calculating a percentage of the type. The list creation unit 133 stores the total number “3” (+1*3) of all the operation parts in the pattern P11 in each of two cells in which a row of the pattern P11 and columns indicating the types of the pattern P11, such as the “improvement system” and the “stop system”, intersect each other.

The list creation unit 133 stores the total number “3” (+1*3) of all the operation parts in the pattern P12 in each of two cells in which a row of the pattern P12 and columns indicating the types of the pattern P12, such as the “improvement system” and the “stop system”, intersect each other.

The list creation unit 133 stores the total number “3” (+1*3) of all the operation parts in the pattern P3 in a cell in which a row of the pattern P3 and a column indicating the type of the “improvement system” of the pattern P3.

The list creation unit 133 calculates the total number “6” (3+3) of all the operation parts in the patterns P11 and P12 having the same type of the improvement system as a total match rate. The list creation unit 133 stores the calculated total match rate “6” in a cell in which a row indicating the total match rate and a column indicating the improvement system intersect each other.

Furthermore, the list creation unit 133 calculates the total number “9” (3+3+3) of all the operation parts in the patterns P11, P12, and P3 having the same type of the stop system as a total match rate. The list creation unit 133 stores the calculated match rate “9” in a cell in which a row indicating the total match rate and a column indicating the stop system intersect each other.

The list creation unit 133 calculates a percentage of the type of the Automated Operation Process illustrated in FIG. 17A based on the calculated total match rate (S305).

In the example of FIG. 17, the list creation unit 133 calculates, in the unit of percentage, a ratio by dividing the total match rate in each type with the total amount of the total match rates. Specifically, the list creation unit 133 calculates the improvement system as 40% ((6/15)×100). The list creation unit 133 stores this calculated percentage “40%” in a cell in which a row indicating the percentage and a column indicating the improvement system intersect each other. Then, the list creation unit 133 calculates the stop system as 60% ((9/15)×100). Then, the list creation unit 133 stores this calculated percentage “60%” in a cell in which a row indicating the percentage and a column indicating the stop system intersect each other.

The list creation unit 133 determines the type “stop system” with the highest percentage (60%) as the type of the Automated Operation Process illustrated in FIG. 17A (S306).

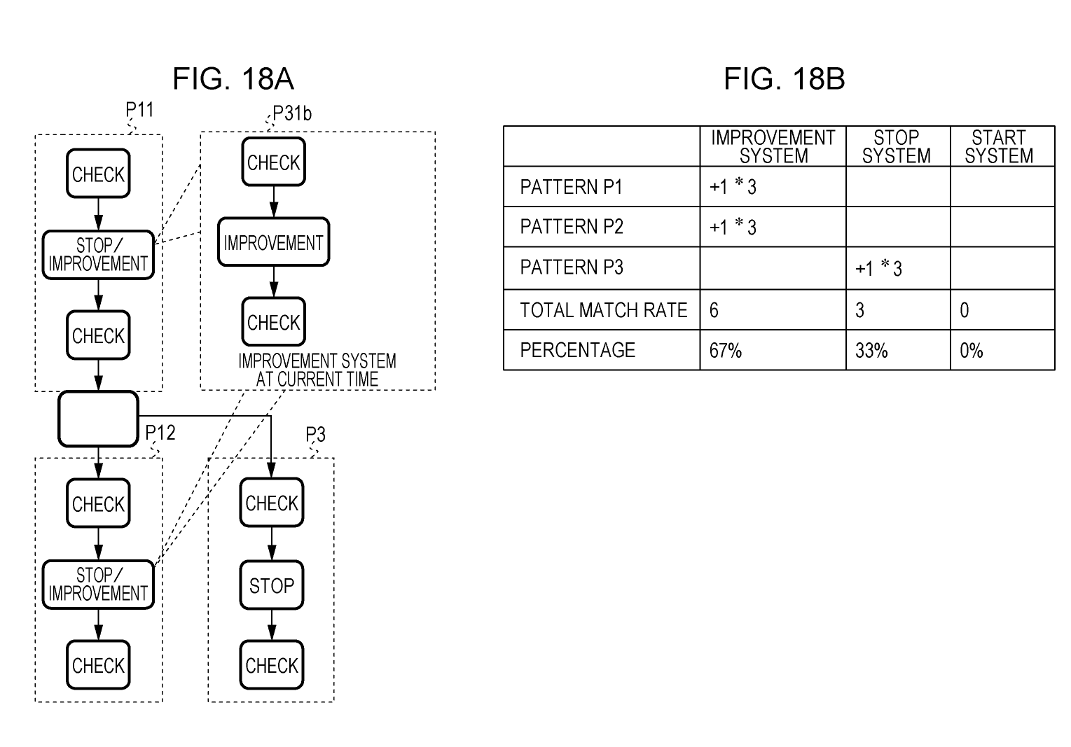

A second method in a case of determining the type of the Automated Operation Process including the multi-process operation part is described by using FIGS. 18A and 18B.

FIG. 18A is a diagram in which a pattern 31 is deleted from FIG. 17A. FIG. 18B is same as FIG. 16B.

A second method is a method of determining the type of process which is executed in the operation parts having multiple types (operation parts of other processes) based on the execution information and the current time and comparing the type of the operation parts having a single type and the type of the process determined in the operation parts having multiple types with the master pattern MP. This execution information is information indicating whether or not any of the multiple processes in the operation parts having the multiple types is executed according to the time. This execution information is stored in advance in the storage 12, for example.

The second method is described in detail. As described in FIGS. 17A and 17B, the multi-process operation part executes one type of process according to time slots. For example, in the time slot of working hours, the multi-process operation part executes the process of the improvement system on an operation target. Also, in the time slot of a time other than the working hours, the multi-process operation part executes the process of the stop system on an operation target. The information indicating whether or not any of the processes is executed according to the time slots is the execution information.

Using this function of the multi-process operation part, the list creation unit 133 uniquely determines the type of the multi-process operation part according to the time for determining the type of the Automated Operation Process. In the example described above, the list creation unit 133 regards the multi-process operation part as the improvement system operation part when the time determining the type of the Automated Operation Process (hereinafter, expressed as a current time) is in the time slot of the working hours. In the example in FIGS. 18A and 18B, the patterns P11 and P12 are regarded as the pattern P31b.

In other words, the Automated Operation Process illustrated in FIG. 18A is regarded as the Automated Operation Process illustrated in FIG. 16A. Then, as described in FIGS. 16A and 16B, the list creation unit 133 calculates the total number of all the operation parts in the patterns having the same type as a total match rate. Then, the list creation unit 133 calculates the percentage of this type based on the total match rate (S305). As for the calculation result of the percentage of the type, see FIG. 18B.

As illustrated in FIGS. 17A to 18B, even in the case of the multi-process operation part, the type of the Automated Operation Process including the multi-process operation part may be determined by determining the type of the operation part.

The list creation unit 133 executes the process described in FIGS. 15A to 18B on all the display target Automated Operation Processes and determines the types of all the display target Automated Operation Processes.

The list creation unit 133 executes a determination process of the display order after the types of all the display target Automated Operation Processes are determined. Specifically, the list creation unit 133 groups the multiple display target Automated Operation Processes for each of the types in determining the display order and determines the information about the display target Automated Operation Process to display for each of the grouped Automated Operation Processes.

Then, the list creation unit 133 determines the display order of all the display target Automated Operation Processes based on start histories of the Automated Operation Process or usage of hardware resources (for example, CPU and memory) in the operation target server.

Here, the type of the Automated Operation Process to be executed has a certain tendency according to the time slots. For example, in the time slot before the working hours (for example, from 4:00 am to 8:00 am), the operation target is stared. Thus, the frequency (number) of executing the start system Automated Operation Process increases. On the other hand, the time slot after the working hours (for example, after 8:00 pm), the operation target is stopped, and the frequency of executing the stop system Automated Operation Process increases.

Accordingly, when the Automated Operation Process with the higher execution frequency is preferentially displayed in the time which is instructed by the operator X to display the Automated Operation Process so as to follow the certain tendency, it is assumed that a possibility of preferentially displaying the Automated Operation Process which is desired by the operator X is increased.

In this manner, since the Automated Operation Process which is desired by the operator X is preferentially displayed, the list creation unit 133 determines the display order of the display target Automated Operation Processes based on the start histories.

### (Start History)

A start history of the Automated Operation Process is described. The start history includes the type of the executed Automated Operation Process, the executed time, the number of executing the executed Automated Operation Process corresponding to this type, and the information about the operation target of the executed Automated Operation Process. When the operation target is a server, the information about the operation target of an executed Automated Operation Process is information specifying the server (for example, an IP address or a machine name). Also, when the operation target is installed software, this information is information to specify the server in which this software is installed.

The start history desired when the display order of the display target Automated Operation Process is the following start histories. In other words, they are start histories of servers (the server 41 and server 42) in a tenant (for example, the tenant A4) to which the designated operation target server (for example, the server 41) belongs or start histories of the Automated Operation Process executing the process on the software installed in this server.

First, the list creation unit 133 determines the type of the executed Automated Operation Process. Then, the list creation unit 133 stores a time when the Automated Operation Process is performed, the information about the operation target of the executed Automated Operation Process, the type of the Automated Operation Process, and the number of executing the Automated Operation Process as the start histories in the storage 12. Here, the operation parts which are referred to in the type determination are the operation parts which are actually executed on the normal route (see FIG. 15A). The execution history is described by referring to FIGS. 15A to 20.

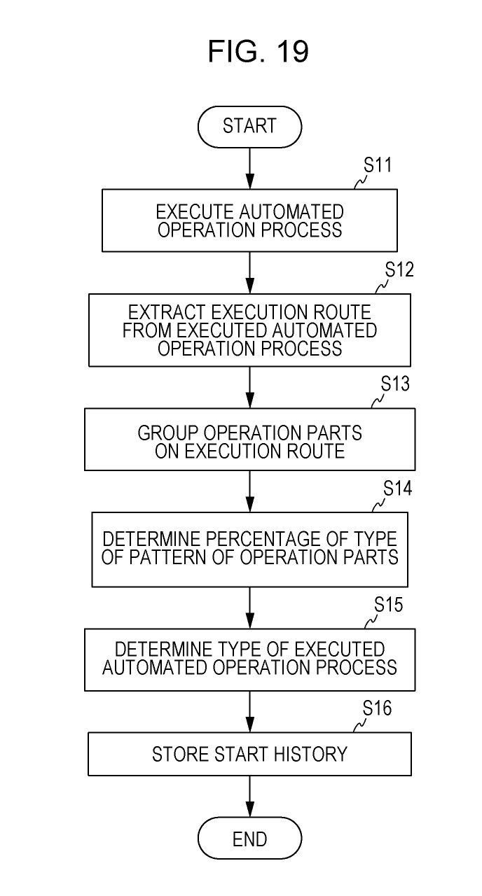

FIG. 19 is an example flowchart illustrating the creation process for the start history.

Step S11: The process processing unit 132 of the management server 1 executes the Automated Operation Process in response to an instruction from the operator. The process processing unit 132 stores the information about the operation target of the executed Automated Operation Process in the RAM 13.

Step S12: The process processing unit 132 extracts an execution route in the executed Automated Operation Process.

For example, it is assumed that the Automated Operation Process illustrated in FIG. 15A is the executed Automated Operation Process. Then, in the example of FIG. 15A, the process processing unit 132 assumes that a route of a series of nodes connected between the start node and the node of the normal termination 1 is executed (see dotted arrows). In this case, the process processing unit 132 extracts the executed route (execution route).

Then, the process processing unit 132 outputs the identifier of the executed Automated Operation Process and the information about the execution route in the executed Automated Operation Process to the list creation unit 133. This information is information of the nodes on the execution route.

Step S13: The list creation unit 133 groups the operation parts on the execution route. The process of grouping the operation parts on the execution route is same as the process of grouping the operation parts on the normal route, which is described at step S303 in FIG. 9 and in FIGS. 15B to 15D. Thus, the detailed description thereof is omitted. In the example of FIGS. 15A to 15D, the list creation unit 133 groups the operation parts on the execution route denoted by the dotted line in FIG. 15A as targets.

Step S14: The list creation unit 133 determines a percentage of the type of the operation parts on the execution route.

The process of determining the percentage is same as the process of determining the percentage of the type of the operation parts on the normal route as described in step 305 in FIG. 9 and FIGS. 16A to 18B, and the detailed description thereof is omitted.

In the example of FIGS. 16A and 16B, when the operation parts on the execution route are the operation parts in the patterns P1 and P2, the list creation unit 133 determines a percentage of the type of the operation parts for each of the patterns P1 and P2. In this case, the list creation unit 133 determines that the patterns P1 and P2 are the improvement system. Then, the list creation unit 133 calculates a total match rate for each of the patterns P1 and P2. In this case, the list creation unit 133 calculates the total match rate of the improvement system as “6” and the total match rate of the stop system or the start system as “0”.

In the example of FIGS. 17A and 17B, when the operation parts on the execution route are the operation parts in the patterns P11 and P12, the list creation unit 133 determines a percentage of the type of the operation parts for each of the patterns P11 and P12. In this case, the list creation unit 133 determines that the patterns P11 and P12 are the improvement system and the stop system. Then, the list creation unit 133 calculates a total match rate for each of the patterns P11 and P12. In this case, the list creation unit 133 calculates the total match rate of the improvement system as “6” and the total match rate of the stop system as “0”.

The example of FIGS. 18A and 18B is same as the example of FIGS. 16A and 16B, and the description thereof is omitted.

Step S15: The list creation unit 133 determines the type of the executed Automated Operation Process based on the percentage of the type in the executed Automated Operation Process. The list creation unit 133 determines the type of the heist percentage as the type of the executed Automated Operation process in determining the type of the executed Automated Operation Process.

The process of determining the type of the executed Automated Operation Process same as the determination process for the type of the Automated Operation Process described at step S306 and in FIGS. 16A to 18B, and the detailed description thereof is omitted.

In the example of FIGS. 16A and 16B, the list creation unit 133 calculates the total match rate of the improvement system as “6”, the total match rate of the stop system or the start system as “0” (S14). The list creation unit 133 calculates, in the unit of percentage, a ratio by dividing the total match rate in each type with the total amount of the total match rates. Specifically, the list creation unit 133 calculates a percentage of the improvement system as 100% ((6/6)×100). The list creation unit 133 determines the type of the “improvement system” with the highest percentage (100%) as the type of the executed Automated Operation Process (S15).

In the example of FIGS. 17A and 17B, the list creation unit 133 calculates the total match rate of the improvement system as “6”, the total match rate of the stop system as “6”, and the total match rate of the start system as “0”.

The list creation unit 133 calculates the total match rate of the improvement system as 50% ((6/12)×100). Then, the list creation unit 133 calculates the total match rate of the stop system as 50% ((6/12)×100). The list creation unit 133 determines the type of the “improvement system” or the “stop system” with the highest percentage as the type of the executed Automated Operation Process (S15). In this manner, when there are multiple types with the highest percentage, the list creation unit 133 determines any of the types as the executed Automated Operation Process.

Step S16: The list creation unit 133 stores the start histories in the storage 12. Specifically, the list creation unit 133 stores time when the Automated Operation Process is executed, information about an operation target of the executed Automated Operation Process (for example, an IP address of a server), and the number of executing this Automated Operation Process corresponding to the determined type (for example, a “stop system”) as start histories in the storage 12.

FIG. 20 is a diagram schematically illustrating the start history.

A history table BH storing start histories has columns of start history name, time, operation target, type, and number of executions. The history table BH schematically illustrates the first start history BH1 to the m-th start history BH, which are stored in the storage 12 in FIG. 2.

It is assumed here that an Automated Operation Process is executed at 7:00, an operation target of the executed Automated Operation Process is software installed in the server 41 in FIG. 1, a type of the executed Automated Operation Process is a “stop system”, and the Automated Operation Process is executed once. In this case, the list creation unit 133 stores “1st start history” identifying a start history in the column of start history name. Then, the list creation unit 133 stores “7:00” in the column of time corresponding to the “1st start history”, stores the “server 41” as the operation target, stores the “stop system” in the column of type, and stores “1” in the column of number of executions.

### (Determination of Display Order)

Referring to FIGS. 21 to 23, a determining process for a display order of information about the retrieved Automated Operation Process is described.

FIG. 21 is a flowchart illustrating an example process flow of determining a display order of information about the retrieved Automated Operation Process based on the determined type. In the description of FIG. 21, the type of the retrieved Automated Operation Process (the display target Automated Operation Process) has been already determined. Then, as described in step S1 in FIG. 5, the list creation unit 133 has acquired the information specifying the operation target server(for example, the IP address of the server and the name of the server).

Step S401: The list creation unit 133 acquires a current time. It is to be noted that a time is measured by an operation system (OS) which is executed by the management server 1. The list creation unit 133 acquires a current time from this OS.

Step S402: The list creation unit 133 determines whether or not the start history (hereinafter expressed as the start history X) of the Automated Operation Process executing the process on the server in the tenant to which the operation target server designated by an operator X belongs is stored in the storage 12. When the start history X is stored in the storage 12 (S402/YES), the process proceeds to step S403.

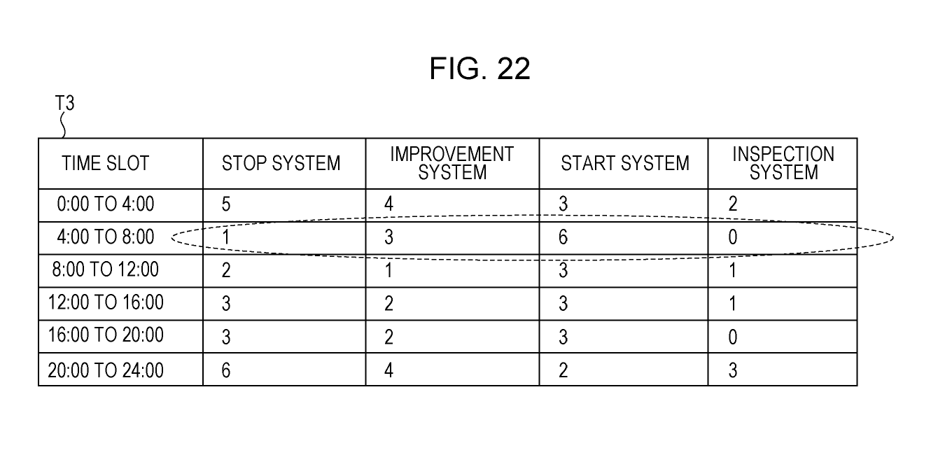

Step S403: The list creation unit 133 counts the start histories per time slot. This counting is described in detail in FIG. 22.

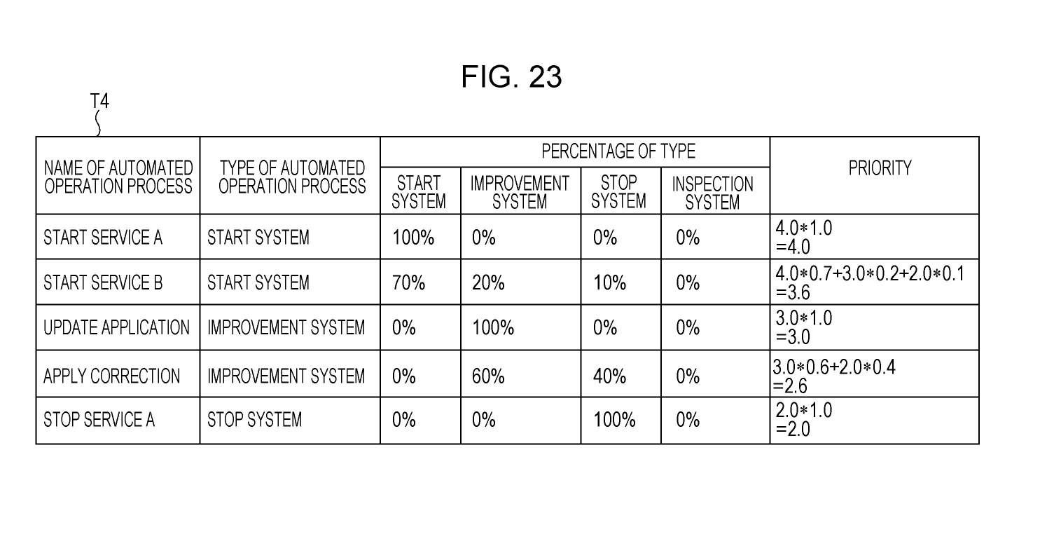

Step S404: The list creation unit 133 calculates a priority of each display target Automated Operation Process based on the start histories counted per time slot. This calculation is described in detail in FIG. 23.

Step S405: The list creation unit 133 determines the display order of information about the display target Automated Operation Process based on the priorities. This determination is described in detail in FIG. 23.

In step S402, when the start history X is not stored in the storage 12 (S402/NO), the step proceeds to step S406.

Step S406: The list creation unit 133 measures a usage of a hardware resource in the operation target designated by the operator X.

Step S407: The list creation unit 133 calculates a priority of each display target Automated Operation Process based on the measured value.

Steps S406 and 5407 are described later in the description of FIG. 23. (Counting of Start Histories)

FIG. 22 is a diagram illustrating a process of counting start histories per time slot at step S403 in FIG. 19.

In the description of FIG. 22, for example, as the start histories of the Automated Operation Process executing the process on the server in the tenant A4 to which the operation target server 41 (see FIG. 1) designated by an operator X belongs, the first start history to the K-th (K is an integer equal to or larger than 2) start history are stored in the storage 12.

A counting table T3 has a column of time slot and columns of a stop system, improvement system, start system, and inception system, which are columns of types. The counting table T3 is stored in the storage 12 or the RAM 13, for example.

Hereinafter, for example, the time slots are determined for every 4 hours by using 0:00 as a reference. The list creation unit 133 stores the time slots of “0:00 to 4:00”, “4:00 to 8:00”, . . . , “20:00 to 24:00” in each of rows in the column of time slot in the counting table T3.

The list creation unit 133 calculates the total number of the times of executing each type (the “stop system”, “improvement system”, “start system”, or “inspect system”) for the start history in the time in the time slot including a current time (S403). Hereinafter, the time slot including a current time is expressed as a current time slot as appropriate. Then, in FIG. 22, the list creation unit 133 stores the total number of the calculated types in a cell in which a row of the current time slot and a column of each type intersect each other.

The case of the start history in FIG. 20 is illustrated as an example. It is assumed that other than the start histories illustrated in FIG. 20, the start history including a time in the time slot “4:00 to 8:00” is not stored in the history table BH in FIG. 20. Then, it is also assumed that the operation target server in the history table BH in FIG. 20 is a server which belongs to the tenant A4 in FIG. 1.

It is assumed here that a current time is 7:00. Using FIG. 20 as an example, the list creation unit 133 calculates the total number of executing the type “stop system” as “1” for the first to tenth start histories including the time in the current time slot (4:00 to 8:00). In the case of FIG. 20, the list creation unit 133 calculates the total number of executing the type “start system” as “6” for the first to tenth start histories including the time in the current time slot (4:00 to 8:00). In the case of FIG. 20, the list creation unit 133 calculates the total number of executing the type “improvement system” as “3” for the first to tenth start histories including the time in the current time slot (4:00 to 8:00). It is to be noted that according to the start histories in FIG. 20, the total number of executing the inspection system is 0.

In the counting table T3, the list creation unit 133 stores the total number of each of the calculated types (see the ellipse illustrated by a dotted line in FIG. 22) in a cell in which a row of the current time slot and a column of each type intersect each other. For example, the list creation unit 133 stores “1” in a cell in which the row of the current time slot (4:00 to 8:00) and the column of the type “stop system” intersect each other. The list creation unit 133 stores “3” in a cell in which the row of the current time slot (4:00 to 8:00) and the column of the type “improvement system” intersect each other. The list creation unit 133 stores “6” in a cell in which the row of the current time slot (4:00 to 8:00) and the column of the type “start system” intersect each other. Then, the list creation unit 133 stores “0” in a cell in which the row of the current time slot (4:00 to 8:00) and the column of the type “inspection system” intersect each other.

It is to be noted in FIG. 22 that values of the time slots other than the current time slot (4:00 to 8:00) are reference values.

### (Calculation of Priority)

Referring to FIG. 22, the priority calculation process is described. First, the list creation unit 133 determines a weighting coefficient of each type based on types of the Automated Operation Processes executed in predetermined time slots and frequency information indicating an execution frequency of the Automated Operation Process corresponding to each type. One example of this frequency information is the counting table T3 in FIG. 22. In FIG. 22, the execution frequency of the Automated Operation Process corresponding to the type is the number of executions of the Automated Operation Process corresponding to the type (such as the “stop system” or “improvement system”) of the counting table T3, for example.

The priority calculation process is specifically described. For each type, the list creation unit 133 determines and sets the weighting coefficient with a value according to the number of executions of the Automated Operation Process. In the example of FIG. 22, when the current time is 7:00, the number of executions in the current time slot (“4:00 to 8:00”) is 6 for the start system, 3 for the improvement system, 1 for the stop system, and 0 for the inspection system. Accordingly, for example, the list creation unit 133 sets the weighting coefficient “4” to the start system and the weighting coefficient “3” to the improvement system. Then, for example, the list creation unit 133 sets the weighting coefficient “2” to the stop system and sets the weighting coefficient “1” to the inspection system.

Next, the list creation unit 133 determines the order of displaying the information about the display target Automated Operation Process based on the weighting coefficient determined (set) for each type and the scores of the types of groups in the display target Automated Operation Process.

For example, with respect to the total of the scores of the types of all the groups in the display target Automated Operation Process, the list creation unit 133 calculates a percentage of each type in the groups in the display target Automated Operation Process. Then, the list creation unit 133 multiples the calculated percentage of each type by the weighting coefficient corresponding to the type, and calculates the total sum of the multiplication values in the display target Automated Operation Process (S404). The total sum of the multiplication values in the display target Automated Operation Process is a priority.

FIG. 23 is a diagram illustrating a process of calculating a priority for each display target Automated Operation Process in step S404 in FIG. 19. A priority table T4 in FIG. 23 is stored in the storage 12 or the RAM 13, for example.

A priority table T4 has columns of Automated Operation Process name, Automated Operation Process type, type percentage, and priority. The column of type percentage has columns of start system, improvement system, stop system, and inspection system. The column of type percentage stores percentages of the types (see FIGS. 16B, 17B, and 18B).

As illustrated in FIG. 23, the list creation unit 133 stores the name of the display target Automated Operation Process in the column of Automated Operation Process name and stores the type of this Automated Operation Process in the column of Automated Operation Process type. Then, the list creation unit 133 stores the percentages of the start system, improvement system, stop system, and inspection system in this Automated Operation Process in the columns of the start system, improvement system, stop system, and inspection system. The percentage of the type is a percentage of the type of each pattern of the operation parts grouped in the display target Automated Operation Process.

Then, the list creation unit 133 calculates the priority of this Automated Operation Process and stores it in the column of priority.

It is assumed that the percentage of the type “start system” is 100% in the Automated Operation Process of the name “start service A”. Then, in the example of FIG. 22, the weighting coefficient of the start system is “4”. Accordingly, the list creation unit 133 calculates 4.0*1 (100%/100) as the priority of the Automated Operation Process of the name “start service A” and stores it in the column of priority.

In addition, it is also assumed that the percentage of the type “start system” is 70%, the percentage of the type “improvement system” is 20%, and the percentage of the type “stop system” is 10% in the Automated Operation Process of the name “start service B”. Then, in the example of FIG. 22, the weighting coefficient of the start system is “4”, the weighting coefficient of the improvement system is “3”, and the weighting coefficient of the stop system is “2”. Accordingly, the list creation unit 133 calculates 3.6 (=4.0*0.7+3.0*0.2+2.0*0.1) as the priority of the Automated Operation Process of the name “start service B” and stores it in the column of priority.

(Calculating Weighting Coefficient with no Start History)

Hereinafter, described is a process which is performed when it is determined in the determination at step S402 in FIG. 19 that there is no start history of the Automated Operation Process executing the process on the server in the tenant to which the operation target server designated by an operator X belongs (S404/N0).

The list creation unit 133 measures the situation of utilizing the server in the operation target server designated by the operator X with the usage of the hardware resource (for example, CPU, RAM, or storage). Specifically, the list creation unit 133 measures the usage of the hardware resource in the operation target server designated by the operator X (S406).

The list creation unit 133 determines whether or not the measured value exceeds a threshold and determines a weighting coefficient setting to each type according to the determination result. Here, when the measurement target hardware resource is a CPU, the measured value is the number of clocks. When the measurement target hardware resource is a RAM or storage, the measured value is a free space of the RAM or storage. It is to be noted that the threshold is stored in the storage 12 in advance. In addition, the threshold may be a threshold included in the server monitoring tool which is executed in the management server 1.

When the measurement value exceeds the threshold, the list creation unit 133 determines that there are many users of the server in the operation target server designated by an operator, and increases the priority order of the Automated Operation Process which preferentially performs recovery. It is assumed here that the types of the Automated Operation Processes which preferentially perform recovery are the “stop system”, “improvement system”, and “start system”. The priorities of the types are the “stop system”, “start system”, and “improvement system” in this order.

The list creation unit 133 sets the weighting coefficient to the types in this order. For example, the list creation unit 133 sets the weighting coefficient “4” to the stop system and sets the weighting coefficient “3” to the start system. Then, for example, the list creation unit 133 sets the weighting coefficient “2” to the improvement system and sets the weighting coefficient “1” to the inspection system.

On the other hand, when the measured value is equal to or smaller than the threshold, the list creation unit 133 determines that there are few users of the service in the operation target server designated by the operator X, and increases the priority order of the Automated Operation Process which preferentially performs inspection. Here, the type of the Automated Operation Process which preferentially performs inspection is the “inspection system”. Then, the priority of this type “inspection system” is caused to be the highest, and the priorities of the types other than that are set in the order of the “stop system”, “start system”, and “improvement system”, for example.

The list creation unit 133 sets the weighting coefficient to each of the types in this order. For example, the list creation unit 133 sets the weighting coefficient “4” to the inspection system and sets the weighting coefficient “3” to the stop system. Then, for example, the list creation unit 133 sets the weighting coefficient “2” to the start system and sets the weighting coefficient “1” to the improvement system.

Hereinafter, as described in FIG. 23, the list creation unit 133 calculates the total sum of a product of the percentage of each type in the display target Automated Operation Process and the weighting coefficient of the type as the priority of the display target Automated Operation Process (S404).

### (Display of Automated Operation Process)

Then, the list creation unit 133 determines to display information about the display target Automated Operation Process in the order from the higher order (in other words, larger total sum) (S405). Specifically, the list creation unit 133 rearranges the display target Automated Operation Processes so as to display them in the order from the higher priority. Then, the list creation unit 133 creates display data of the rearranged Automated Operation Processes in the HTML format, for example, and transmits it to the client terminal 2.

The client terminal 2 displays the information about the Automated Operation Process in the display device based on the received display data.

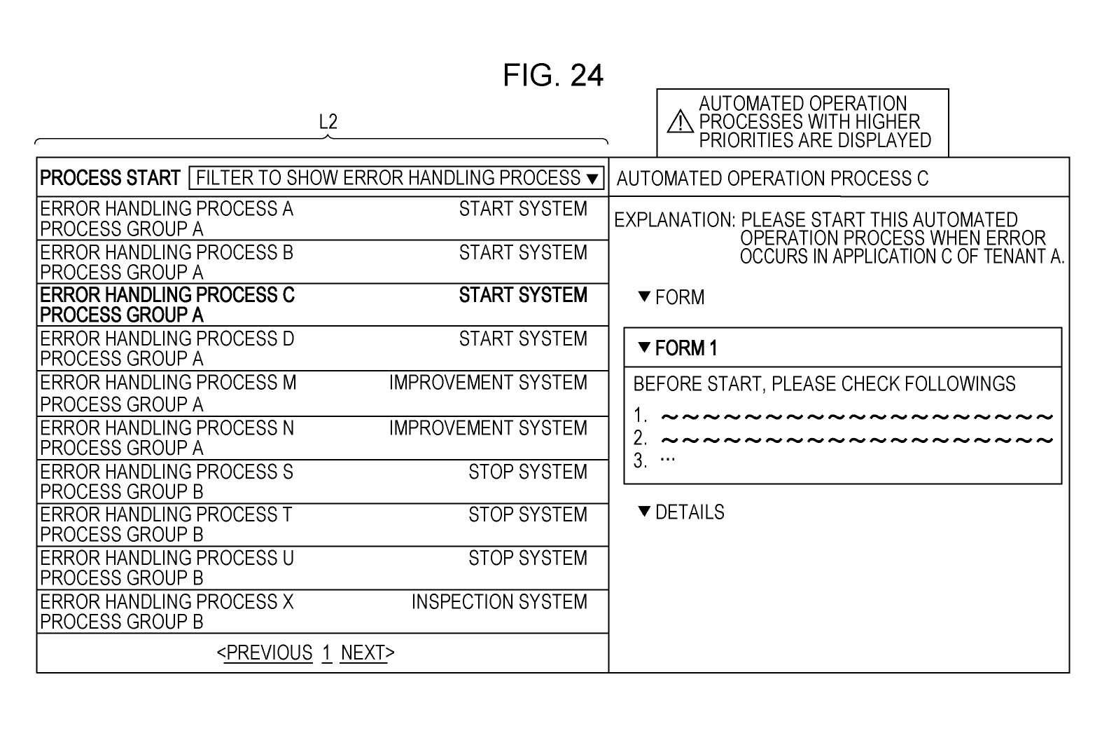

FIG. 24 is a diagram illustrating an example display of the Automated Operation Process in the embodiment. In FIG. 24, as denoted by reference numeral 12, the name of the Automated Operation Process is displayed in a list format.

Here, as described in FIG. 23, in the list display column L2, the types of the Automated Operation Processes are classified and displayed. Accordingly, the embodiment allows the operator to easily find an Automated Operation Process with a main purpose (main type) which is desired to be executed by the operator. For example, when an operator desires to execute the start system Automated Operation Process, the Automated Operation processes in the start system are displayed in the classified manner, the operator may easily find a desired Automated Operation Process among them.

Furthermore, in the embodiment, the Automated Operation Process with the type having a higher priority is displayed in an upper side of the list. More specifically, as described in the start history, the type of the executed Automated Operation Process has the certain tendency according to the time slots. In the management server of the embodiment, in order to follow the certain tendency, the Automated Operation Process with the type having a larger execution frequency is preferentially displayed at time which is instructed by an operator to display the Automated Operation Process. Accordingly, a possibility that an Automated Operation Process which is desired by an operator is preferentially displayed is increased and the desired Automated Operation Process may be easily found.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
dividing multiple processes in a process definition, in which the multiple processes for an operation target in an information processing system are defined, into multiple groups based on partition information indicating a partition of a unit of the processes;
determining a type of each of the divided groups based on the processes belonging to the group; and
determining a type of the process definition based on the determined types of the groups.

2. The non-transitory computer-readable recording medium according to claim 1, wherein
in the dividing, two or more of process definitions each defined to execute multiple processes on a designated operation target are retrieved from a plurality of the process definitions stored in a storage unit and the multiple processes in each of the retrieved process definitions are divided into groups,
in the determining a type of each of the divided groups, a type of each of the groups in each of the retrieved process definitions is determined based on the processes belonging to the group in the retrieved process definition,
in the determining a type of the process definition, the type of each of the retrieved process definitions is determined based on the types of the groups in the retrieved process definition, and
the process further comprises determining an order of displaying information about the retrieved process definitions based on the types of the respective retrieved process definitions.

3. The non-transitory computer-readable recording medium according to claim 2, wherein
the process definition includes a first node defined for each of the processes to indicate the process and the type of the process, at least one second node being the partition information indicating a partition of a unit of the processes expressed by one or more first nodes, and connection information indicating a connection relationship between the first and second nodes,
in the dividing into the groups, multiple first nodes in each of the retrieved process definitions are divided into multiple groups by using the second node as a reference,
in the determining the type of each of the groups, type information stored in a storage unit and indicating the type of one or more first nodes patterned and a connection relationship between the patterned first nodes is compared with the type of one or more first nodes in the group, and the type of one or more patterned first nodes matching the type of the one or more first nodes in the group, is determined as the type of the group and
in the determining a type of the process definition, the most dominant type among the types of the groups in the retrieved process definition is determined and the determined type is determined as the type of the retrieved process definition.

4. The non-transitory computer-readable recording medium according to claim 2, wherein
in the determining the display order, the multiple retrieved process definitions are grouped by type and displaying information about the retrieved process definitions is determined for each group of the process definitions.

5. A determination device, comprising:
a storage unit configured to store a process definition in which multiple processes for an operation target in an information processing system are defined; and
a processing unit configured to divide the multiple processes in the process definition into multiple groups based on partition information indicating a partition of a unit of the processes, determine a type of each of the divided groups based on the processes belonging to the group, and determine a type of the process definition based on the determined types of the groups.

6. A determination method to be executed by a management device configured to manage an information processing system, the determination method comprising:
dividing, multiple processes in a process definition in which the multiple processes for an operation target in the information processing system are defined, into multiple groups based on partition information indicating a partition of a unit of the processes,
determining a type of each of the divided groups based on the processes belonging to the group, and
determining a type of the process definition based on the determined types of the groups.
